(19) United States
(12) Patent Application Publication
(10) Pub. No.: US 2011/0051812 A1
(43) Pub. Date: Mar. 3, 2011

(54) Video Transmitting Apparatus, Video Receiving Apparatus, Video Transmitting Method, and Video Receiving Method

(76) Inventors: Junichi TANAKA, Kanagawa (JP); Yoichi Yagasaki, Tokyo (JP); Takuya Kitamura, Tokyo (JP)

(21) Appl. No.: 12/868,254

(22) Filed: Aug. 25, 2010

(30) Foreign Application Priority Data
Sep. 1, 2009 (JP) P2009-201796

(51) Int. Cl. H04N 7/64; H04N 7/32

(52) U.S. Cl. 375/240.12; 375/E07.243; 375/E07.279

(57) ABSTRACT

A video transmitting apparatus includes: an error receiver that receives, from a video receiving apparatus for receiving a bit stream resulting from encoding of video data including pictures, error information indicating that an error is detected; an encoding-mode selector that selects a propagation-prevention encoding mode as an encoding mode when the error receiver receives the error information; and an encoder that encodes the video data in accordance with the selected encoding mode. In the propagation-prevention encoding mode, intra coding is executed on a forced intra block; a search range is set for a reference encoding unit so as not to include correspondent pixels from a boundary line serving as a boundary between the forced intra block and another block, the correspondent pixels corresponding to the number of adjacent pixels; and a restriction is set on deblocking-filter processing through a change in deblocking-filter setting information.

### BACKGROUND OF THE INVENTION

1. Field of the Invention

The present invention relates to a video transmitting apparatus, a video receiving apparatus, a video transmitting method, and a video receiving method, which are preferably applied to, for example, an encoding apparatus that encodes video data distributed through terrestrial digital broadcast.

2. Description of the Related Art

Wireless transmission technology for wirelessly transmitting HD (high definition) moving-image data to display apparatuses, such as wall-hanged televisions, placed at remote locations has been developed. Transmission systems used for the wireless transmission technology employ, for example, millimeter waves using a 60 GHz band, an IEEE (Institute of Electrical and Electronics Engineers) 802.11n (wireless LAN [local area network]) using a 5 GHz band, and a UWB (ultra wide band).

In the wireless transmission technology, the HD moving-image data is encoded and compressed for transmission. In the wireless transmission technology, it is desired to minimize the amount of delay from when the HD moving-image data is transmitted until an image is displayed on a display apparatus. This is because a reduction in the amount of delay makes it possible to achieve real-time display of broadcast programs of terrestrial digital broadcast and so on.

For example, in an encoding system in which a picture type is switched for each picture among an I picture, a P picture, and a B picture, the amount of code for the I picture is large compared to the other types of picture. Thus, when this encoding system is applied to the wireless transmission technology, buffering for each GOP (group of picture) having an equal amount of code is performed and the amount of delay is also increased.

Accordingly, as shown in FIG. 1, a video processing apparatus that is adapted to transmit HD moving-image data encoded according to an intra slice method using MPEG (Moving Picture Experts Group) 2 has been proposed (refer to, for example, Japanese Unexamined Patent Application Publication No. 11-205803).

In the intra slice method using MPEG-2, a picture is constituted by I picture areas I_MB to be intra-coded and P picture areas P_MB to be forward-prediction-coded. In the intra slice method, an I picture area having a predetermined number of macroblock lines (this I picture area will hereinafter be referred to as a “refresh line RL”) is caused to appear for each picture. The refresh lines RL appear offset sequentially to thereby appear in all pictures at a cycle T.

Thus, in the intra slice method, the amount of code for each picture can be equalized so as to reduce the amount of delay from when HD moving-image data is transmitted until an image is displayed on the display apparatus.

### SUMMARY OF THE INVENTION

An encoding apparatus with such a configuration causes the I picture areas I_MB to appear in the entire area in one cycle. Since a large amount of code is assigned to the I picture areas I_MB, there are problems in that the amount of code assigned to the P picture areas P_MB is reduced and the image quality is reduced.

In view of the points described above, it is desirable to provide a video transmitting apparatus, a video receiving apparatus, a video transmitting method, and a video receiving method which can improve the image quality.

According to one embodiment of the present invention, there is provided a video transmitting apparatus. The video transmitting apparatus includes: an error receiver that receives, from a video receiving apparatus for receiving a bit stream resulting from encoding of video data including pictures, error information indicating that an error is detected; an encoding-mode selector that selects a propagation-prevention encoding mode as an encoding mode when the error receiver receives the error information; and an encoder that encodes the video data in accordance with the encoding mode selected by the encoding-mode selector. In the propagation-prevention encoding mode, intra coding is executed on a forced intra block; a search range is set for a reference encoding unit so that the search range does not include correspondent pixels from a boundary line serving as a boundary between the forced intra block and a block other than the forced intra block, the correspondent pixels corresponding to the number of adjacent pixels; and a restriction is set on deblocking-filter processing through a change in deblocking-filter setting information.

Thus, according to the video transmitting apparatus in the embodiment of the present invention, it is sufficient that, when an error occurs, the operation enters the propagation-prevention encoding mode in which the image quality is likely to decrease. Thus, it is possible to improve the image quality when no error occurs.

According to another embodiment of the present invention, there is provided a video transmitting method. The video transmitting method includes the steps of: receiving, from a video receiving apparatus for receiving a bit stream resulting from encoding of video data including pictures, error information indicating that an error is detected; selecting a propagation-prevention encoding mode as an encoding mode when the error information is received in the error-information receiving step; and encoding the video data in accordance with the encoding mode selected in the encoding-mode selecting step. In the propagation-prevention encoding mode, intra coding is executed on a forced intra block; a search range is set for a reference encoding unit so that the search range does not include correspondent pixels from a boundary line serving as a boundary between the forced intra block and a block other than the forced intra block, the correspondent pixels corresponding to the number of adjacent pixels; and a restriction is set on deblocking-filter processing through a change in deblocking-filter setting information.

Thus, according to the video transmitting method in the embodiment of the present invention, it is sufficient that, when an error occurs, the operation enters the propagation-prevention encoding mode in which the image quality is likely to decrease. Thus, it is possible to improve the image quality when no error occurs.

According to still another embodiment of the present invention, there is provided a video receiving apparatus. The video receiving apparatus includes: a bit-stream receiver that receives a bit stream transmitted from a video transmitting apparatus, the bit stream resulting from encoding of video data including pictures; a reversible-decoding section that performs reversible decoding on the bit stream; an error detector that detects an error from data of an encoding unit in the bit stream reversible-decoded by the reversible-decoding section, by recognizing that an error exists when a value that deviates from a rule predetermined with the video transmitting apparatus is detected; and an error transmitter that adds, when the error detector detects the error, error position information or error propagation information to error information indicating that the error is detected and that transmits the resulting error information to the video transmitting apparatus, the error position information indicating a position at which the error is detected and the error propagation information indicating an error propagation range in which the error is likely to propagate.

With this arrangement, according to the video receiving apparatus and the video receiving method in the embodiment of the present invention, the video transmitting apparatus can appropriately recognize that an error is detected. Thus, only when an error occurs, the video transmitting apparatus is caused to enter the propagation-prevention encoding mode in which the image quality is likely to decrease. Consequently, it is possible to improve the image quality when no error occurs.

According to yet another embodiment of the present invention, there is provided a video receiving method. The video receiving method includes the steps of: receiving a bit stream resulting from encoding of video data including pictures; performing reversible decoding on the bit stream; detecting an error from data of an encoding unit in the bit stream reversible-decoded in the reversible-decoding step, by recognizing that an error exists when a value that deviates from a rule predetermined with a video transmitting apparatus is detected; and adding, when the error detector detects the error, error position information or error propagation information to error information indicating that the error is detected and transmitting the resulting error information to the video transmitting apparatus, the error position information indicating a position at which the error is detected and the error propagation information indicating an error propagation range in which the error is likely to propagate.

With this arrangement, according to the video receiving method in the embodiment of the present invention, the video transmitting apparatus can appropriately recognize that an error is detected. Thus, only when an error occurs, the video transmitting apparatus is caused to enter the propagation-prevention encoding mode in which the image quality is likely to decrease. Consequently, it is possible to improve the image quality when no error occurs.

According to the present invention, it is sufficient that, when an error occurs, the operation enters the propagation-prevention encoding mode in which the image quality is likely to decrease. Thus, it is possible to improve the image quality when no error occurs. Accordingly, the present invention can realize a video transmitting apparatus, a video receiving apparatus, a video transmitting method, and a video receiving method which can improve the image quality.

### BRIEF DESCRIPTION OF THE DRAWINGS

FIG. 1 is a schematic diagram illustrating an intra slice method;

FIG. 2 is a block diagram showing the configuration of a video processing system;

FIG. 3 is a block diagram showing the configuration of a video encoder;

FIG. 4 is a schematic diagram showing the configuration of a video decoder;

FIGS. 5A and 5B are schematic diagrams illustrating propagation of an error during motion prediction;

FIG. 6 illustrates recovery from an error;

FIG. 7 is a schematic diagram illustrating propagation of an error during motion prediction based on AVC;

FIGS. 8A to 8C are schematic diagrams illustrating prevention of error propagation in a second propagation prevention system;

FIGS. 9A to 9C are schematic diagrams illustrating propagation of a slice boundary and propagation of an error;

FIGS. 10A to 10C are schematic diagrams illustrating prevention of error propagation when the slice boundary is fixed;

FIG. 11 is a schematic diagram illustrating an influence of a deblocking filter;

FIGS. 12A and 12B are schematic diagrams illustrating a search range in the second propagation prevention system;

FIG. 13 is a schematic diagram illustrating a third propagation prevention system;

FIG. 14 is a schematic diagram illustrating appearance of a refresh block for each macroblock;

FIG. 15 is a schematic diagram illustrating supply of uplink information upon detection of packet loss;

FIG. 16 is a schematic diagram illustrating supply of uplink information upon detection of an error from data;

FIGS. 17A to 17C are schematic diagrams illustrating identifying a propagation range and switching between encoding modes;

FIG. 18 is a schematic diagram illustrating switching between the encoding modes;

FIG. 19 is a flowchart illustrating an encoding processing procedure; and

FIG. 20 is a flowchart illustrating a processing procedure for a partial-area propagation prevention mode.

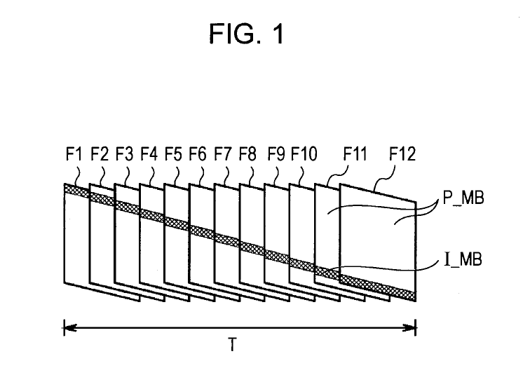

### DESCRIPTION OF THE PREFERRED EMBODIMENTS

Embodiments of the present invention will be described below with reference to the accompanying drawings. A description below is given in the following sequence:

### 1. Embodiments (Mode Switching in AVC Intra Slice Method), and

### 2. Other Embodiments.

### 1. First Embodiment

### 1-1: Configuration of Video Processing System

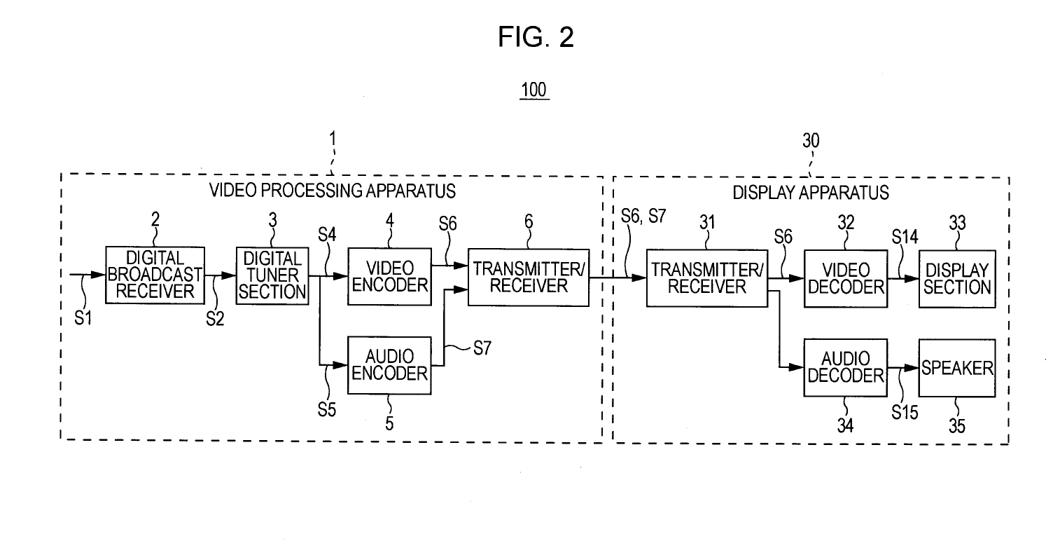

Reference numeral 100 in FIG. 2 generally indicates a video processing system typified by a wireless video-data transmission system. The video processing system 100 is, for example, a wall-mounted television that receives broadcast signals of terrestrial digital broadcast and so on, and has a video processing apparatus 1 and a display apparatus 30.

The video processing apparatus 1 receives broadcast signals S1 and encodes video data, obtained therefrom, in accordance with H.264/AVC (Advanced Video Coding) to generate a bit stream S6. The video processing apparatus 1 wirelessly transmits the bit stream S6 and encoded audio data S7, resulting from encoding of audio data, to the display apparatus 30. The display apparatus 30 decodes the bit stream S6 and the encoded audio data S7 and outputs a resulting image. As a result, the display apparatus 30 allows a user to enjoy broadcast-program content based on the terrestrial digital broadcast and so on.

A digital broadcast receiver 2 is connected to, for example, an antenna or a network such as the Internet, and is provided with an external interface for receiving the broadcast signals S1 of the terrestrial digital broadcast or the like. The broadcast signals S1 are encoded in accordance with, for example, an MPEG (Moving Picture Experts Group) 2 standard.

Upon receiving the broadcast signals S1 representing the broadcast program content, the digital broadcast receiver 2 supplies the broadcast signals S1 to a digital tuner section 3 as broadcast signals S2. The digital tuner section 3 decodes the broadcast signals S2 to generate video data S4 and audio data S5.

The digital tuner section 3 supplies the video data S4 to a video encoder 4 and supplies the audio data S5 to an audio encoder 5. The video encoder 4 performs video encoding processing (described below) for encoding the video data S4 in accordance with H.264/AVC to generate a bit stream S6 and supplies the bit stream S6 to a transmitter/receiver 6.

The audio encoder 5 encodes the audio data S5 in accordance with a predetermined encoding system to generate encoded audio data S7 and supplies the encoded audio data S7 to the transmitter/receiver 6. The transmitter/receiver 6 transmits the bit stream S6 and the encoded audio data S7 by using a wireless transmission system, such as IEEE 802.11n.

As a result, the bit stream S6 and the encoded audio data S7 are supplied to the display apparatus 30. Upon receiving the bit stream S6 and the encoded audio data S7, a transmitter/receiver 31 in the display apparatus 30 supplies the bit stream S6 to a video decoder 32 and supplies the encoded audio data S7 to an audio decoder 34.

The video decoder 32 decodes the bit stream S6 to generate video data S14 corresponding to the video data S4 and supplies the video data S14 to a display section 33. As a result, the display section 33 displays an image based on the video data S14.

The audio decoder 34 decodes the encoded audio data S7 to generate audio data S15 corresponding to the audio data S5 and supplies the audio data S15 to a speaker 35. As a result, the speaker 35 outputs sound based on the audio data S15.

As described above, the video processing system 100 is configured so that encoded broadcast signals are wirelessly transmitted/received between the video processing apparatus 1 and the display apparatus 30.

### 1-2. Configuration of Video Encoder

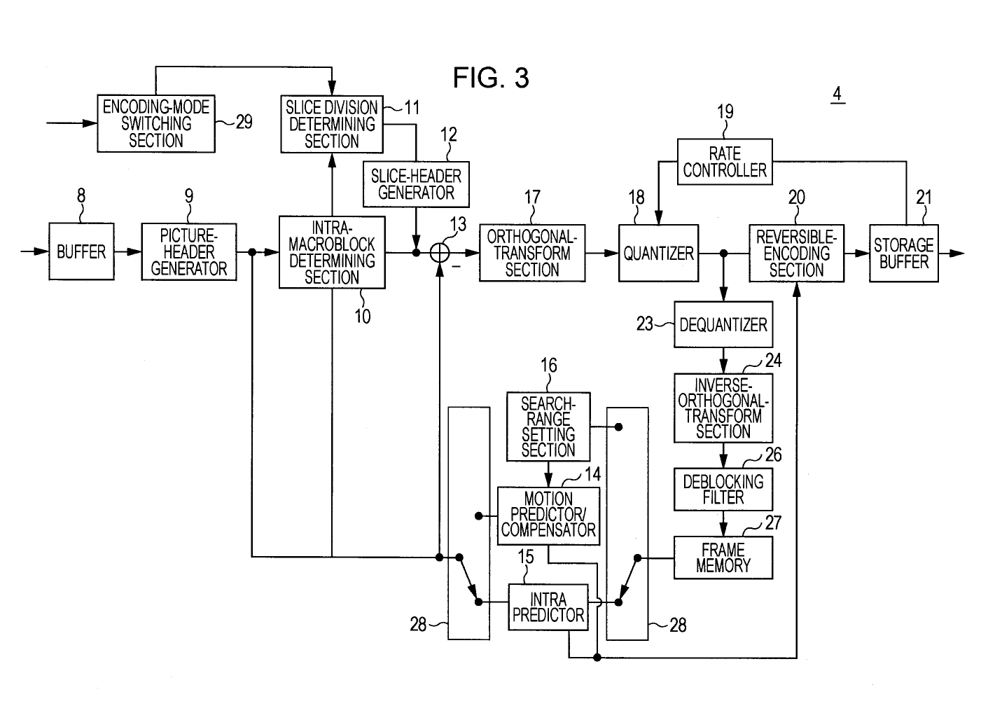

As shown in FIG. 3, when the video data S4 is supplied from the digital tuner section 3 to the video encoder 4, the video data S4 is supplied to a buffer 8.

The buffer 8 supplies the video data S4 to a picture-header generator 9. The picture-header generator 9 generates a picture header, adds the generated picture header to the video data S4, and supplies the resulting video data S4 to an intra-macroblock determining section 10 and also to a motion predictor/compensator 14 or an intra predictor 15. In this case, the picture-header generator 9 adds a flag, such as a constrained_intra_pred_flag (details of which is described below).

An intra-macroblock determining section 10 determines whether each macroblock is to be intra-coded as an I macroblock or is to be inter-coded as a P macroblock. The intra-macroblock determining section 10 supplies the result of the determination to a slice-division determining section 11, a slice-header generator 12, and a switch 28, and also supplies the video data S4 to a computing section 13.

On the basis of the result of the determination performed by the intra-macroblock determining section 10 and so on, the slice-division determining section 11 determines whether or not a slice is to be divided, and supplies the result of the determination to the slice-header generator 12.

The slice-header generator 12 generates a slice header, adds the slice header to the video data S4, and supplies the resulting video data S4 to the computing section 13.

When the video data S4 is to be inter-coded, the computing section 13 subtracts a prediction value L5, supplied from the motion predictor/compensator 14, from the video data S4 and supplies resulting difference data D1 to an orthogonal-transform section 17. When the video data S4 is to be intra-coded, the computing section 13 subtracts a prediction value L5, supplied from an intra predictor 15, from the video data S4 and supplies resulting difference data D1 to the orthogonal-transform section 17.

The orthogonal-transform section 17 orthogonally transforms the difference data D1 by performing orthogonal transform processing, such as DCT (discrete cosine transform) and Karhunen—Loeve transform, and supplies resulting orthogonal-transform coefficients D2 to a quantizer 18.

The quantizer 18 quantizes the orthogonal-transform coefficients D2 by using a quantization parameter QP determined under the control of a rate controller 19, and supplies resulting quantized coefficients D3 to a dequantizer 23 and a reversible-encoding section 20. The reversible-encoding section 20 performs reversible encoding on the quantized coefficients D3 in accordance with CAVLC (Context-based Adaptive Variable Length Coding) or CABAC (Context Adaptive Binary Arithmetic Coding) and supplies resulting reversible encoded data D5 to a storage buffer 21.

The reversible-encoding section 20 obtains information regarding intra-coding and inter-coding from the motion predictor/compensator 14 and the intra predictor 15 and sets the information as header information of the reversible encoded data D5.

The storage buffer 21 stores the reversible encoded data D5 and then outputs the reversible encoded data D5 as the bit stream S6 at a predetermined transmission speed. The rate controller 19 monitors the storage buffer 21 and determines the quantization parameter QP so that the amount of code generated for the reversible encoded data D5 approaches a certain amount of code for each control unit (e.g., a frame or GOP).

The dequantizer 23 generates reproduction orthogonal transform coefficients L1 by dequantizing the quantized coefficients D3 and supplies the resulting reproduction orthogonal transform coefficients L1 to an inverse-orthogonal-transform section 24. The inverse-orthogonal-transform section 24 performs inverse orthogonal transform on the reproduction orthogonal transform coefficients L1 to generate reproduction difference data L2. The inverse-orthogonal-transform section 24 generates a local decoded image L3 by adding the reproduction difference data L2 and simultaneously supplied video data of a block to be referred to and supplies the local decoded image L3 to a deblocking filter 26.

The deblocking filter 26 executes deblocking-filter processing on a block to be processed and supplies a resulting local decoded image L4 to a frame memory 27. Consequently, the local decoded image L4 subjected to the deblocking-filter processing is stored in the frame memory 27.

The frame memory 27 supplies, of the local decoded image L4 subjected to the deblocking-filter processing, the local decoded image L4 corresponding to the block to be referred to the motion predictor/compensator 14 or the intra predictor 15. In this case, the switch 28 is operated in accordance with the result of the determination performed by the intra-macroblock determining section 10.

By referring to the local decoded image L4, the motion predictor/compensator 14 performs motion prediction on the video data S4 to generate the prediction value L5 for the block to be processed. The motion predictor/compensator 14 then supplies the prediction value L5 to the computing section 13. By referring to the local decoded image L4, the intra predictor 15 performs intra prediction on the video data S4 to generate the prediction value L5 for the block to be processed. The intra predictor 15 then supplies the prediction value L5 to the computing section 13. As described above, the video encoder 4 is adapted to encode the video data S4 to generate the bit stream S6.

### 1-3. Configuration of Video Decoder

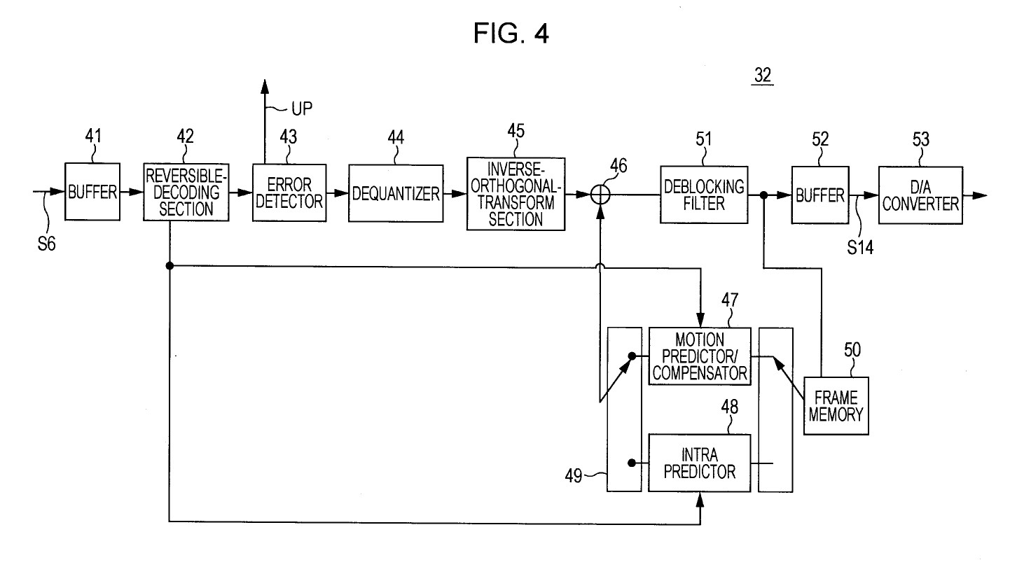

As shown in FIG. 4, when the bit stream S6 is supplied from the transmitter/receiver 31 to the video decoder 32, the bit stream S6 is supplied to a buffer 41.

The buffer 41 supplies the bit stream S6 to a reversible-decoding section 42. The reversible-decoding section 42 performs reversible decoding on the bit stream S6 in accordance with CAVLC or CABAC to generate dequantized coefficients D3 and supplies the dequantized coefficients D3 to a dequantizer 44 via an error detector 43. The reversible-decoding section 42 also determines whether the bit stream S6 is intra-coded or inter-coded on the basis of the reversibly decoded header portion, and supplies the result of the determination to a switch 49.

The dequantizer 44 generates orthogonal-transform coefficients D2 by dequantizing the quantized coefficients D3 and supplies the resulting orthogonal transform coefficients D2 to an inverse-orthogonal-transform section 45. The inverse-orthogonal-transform section 45 performs inverse orthogonal transform on the orthogonal transform coefficients D2 to generate difference data D1 and supplies the difference data D1 to a computing section 46.

When the difference data D1 is inter-coded, the computing section 46 adds a prediction value R1, supplied from a motion predictor/compensator 47, to the difference data D1 and supplies resulting video data D0 to a deblocking filter 51. When the difference data D1 is intra-coded, the computing section 46 adds a prediction value R1, supplied from an intra predictor 48, to the difference data D1 and supplies resulting video data D0 to the deblocking filter 51.

The deblocking filter 51 executes deblocking-filter processing on the video data D0 in accordance with disable_deblocking_filter_idc and supplies resulting video data S14 to a frame memory 50 and a buffer 52.

The frame memory 50 supplies, to the motion predictor/compensator 47 or the intra predictor 48, the video data S14 corresponding to the block to be referred to. In this case, the switch 49 is operated in accordance with the result of the determination performed by the reversible-decoding section 42.

The motion predictor/compensator 47 performs motion prediction by referring to the video data S14 to generate the prediction value R1 for the block to be processed to and supplies the prediction value R1 to the computing unit 46. The intra predictor 48 performs intra-prediction by referring to the video data S14 to generate the prediction value R1 for the block to be processed to and supplies the prediction value R1 to the computing section 46.

The buffer 52 supplies the video data S14 to a D/A (digital/analog) converter 53 at a predetermined speed. The D/A converter 53 converts the video data S14 into analog video data and supplies the analog video data to the display section 33. As a result, the display section 33 displays an image based on the video data S14.

As described above, the video decoder 32 is adapted to decode the bit stream S6 to generate the video data S14.

### 1-4. Normal Encoding Mode and Propagation Prevention Encoding Mode

During normal operation in which the bit stream S6 is transmitted without error, the video processing apparatus 1 in the present embodiment generates a normal encoded bit stream 6Sa, which includes only forward-coded P pictures, as the bit stream S6, and supplies the normal encoded bit stream 6Sa to the display apparatus 30. The normal encoded bit stream 6Sa is decoded through reference to a previous picture. Thus, when an error occurs during transmission, the error propagates.

The video processing apparatus 1 has, as encoding modes, a normal encoding mode and a propagation-prevention encoding mode in which error propagation does not occur. When the display apparatus 30 detects an error, the video processing apparatus 1 enters the propagation-prevention encoding mode, and when error recovery is completed, the video processing apparatus 1 enters the normal encoding mode again.

In addition, the video processing apparatus 1 has first to third propagation prevention systems for the propagation-prevention encoding mode and is adapted to select one of the propagation prevention systems which corresponds to a communication rate.

More specifically, during start of communication, the video processing apparatus 1 determines the communication rate by transmitting/receiving data to/from the display apparatus 30. When the communication rate is low, the video processing apparatus 1 selects the first propagation prevention system. When the communication rate is about medium, the video processing apparatus 1 selects the second propagation prevention system, which can improve the image quality compared to the first propagation prevention system. When the communication rate is high, the video processing apparatus 1 selects the third propagation prevention system, which provides a more favorable image quality than the first and second propagation prevention systems.

Each of the first to third propagation prevention systems is one resulting from adaptation of the intra slice method to H.264/AVC. In the intra slice method based on MPEG-2, a restriction is imposed on the motion-vector search range in order to prevent error propagation. H.264/AVC further has some AVC-specific error propagation causes due to a difference from MPEG-2.

The AVC-specific error propagation causes will be sequentially described below with respect to first to third error propagation causes. The first error propagation cause is a search range for detection of a motion vector.

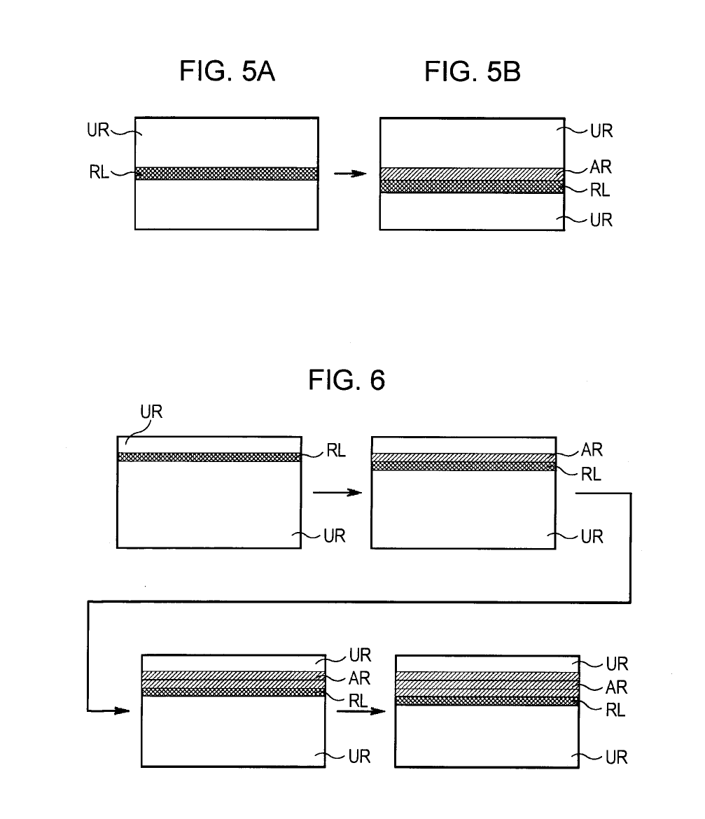

As shown in FIGS. 5A and 5B, in the intra slice method, encoding is performed so that a refresh line RL varies for each picture line by line. The refresh line RL may be a line for each macroblock or may be a line for multiple macroblocks. A line unit at which the refresh line RL appears will hereinafter be referred to as an “encoding line unit”. A line along which macroblocks are arranged in an x direction (a horizontal direction) is referred to as a “macroblock line”. One macroblock line refers to one line along which macroblocks are arranged.

With this arrangement, if an error occurs in one picture during decoding, only the refresh line RL returns in a next picture and the remaining inter-coded areas become unreturned lines UR, as shown in FIG. 5A.

In the intra slice method, through the use of the refresh line RL in an immediately previous picture as a search range, a motion vector is detected to execute encoding. During decoding, a next picture can be decoded with reference to only the refresh line RL, as shown in FIG. 5B, that is, without reference to an unreturned line UR. Thus, a portion corresponding to the refresh line RL that is to be referred to and that is included in the immediately previous picture can be returned as a returned line AR.

As shown in FIG. 6, the number of returned lines AR increases gradually as the refresh line RL appears. When the decoding is finished for a picture with a cycle T, the appearance of the refresh lines RL is completed at all positions and an image can be returned at all positions in the picture.

In H.264/AVC, motion vectors are detected with quarter-pixel precision. Thus, an encoding apparatus that performs encoding processing in accordance with H.264/AVC uses a 6-tap FIR (finite impulse response) filter in order to generate half pixels (pels) and quarter pixels (pels). The 6-tap FIR filter refers to adjacent sixth pixels.

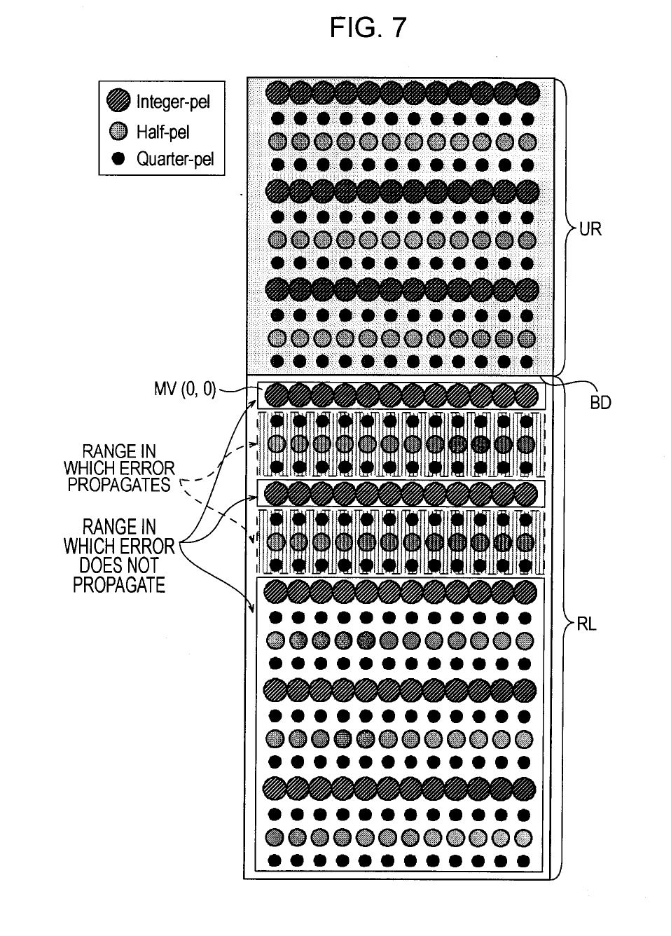

Thus, as shown in FIG. 7, with respect to half pixels and quarter pixels (indicated by vertical lines) located outside (i.e., toward the unreturned line UR from) the three pixels from a boundary between the refresh line RL and the unreturned line UR (the boundary will hereinafter be referred to as a “refresh boundary BD”), the unreturned line UR is referred to. The refresh boundary BD means a boundary that can serve as a boundary between the refresh line RL and the unreturned line UR (i.e., a boundary for each encoding line unit). Although only half pixels and quarter pixels are generated between pixels in the y direction in the example of FIG. 7, half pixels and quarter pixels are also generated in the x direction in practice.

As a result, even within the refresh line RL, an error propagates to the half pixels and quarter pixels located outside the three pixels from the refresh boundary BD. Those pixels to which an error propagates in the refresh line RL are referred to as “error propagation pixels”. Thus, when a motion-vector search range is set for each encoding line unit during encoding, there is a possibility that the error propagation pixels are referred to during decoding to thereby cause the error to propagate to the returned line AR. This is the first error-propagation cause.

In H.264/AVC, intra prediction coding is used for intra coding. The second error-propagation cause is due to the intra prediction coding.

In the intra prediction coding, pixels that are adjacent to an I macroblock to be encoded and that are located at the upper side, the left side, or both sides thereof are referred to. When an I macroblock is located with its upper or left side being adjacent to the refresh boundary BD, the unreturned line UR is referred to and thus an error propagates. This is the second error-propagation cause.

In H.264/AVC, a deblocking filter is used in order to suppress noise induced by deblocking. The third error-propagation cause is due to the deblocking filter.

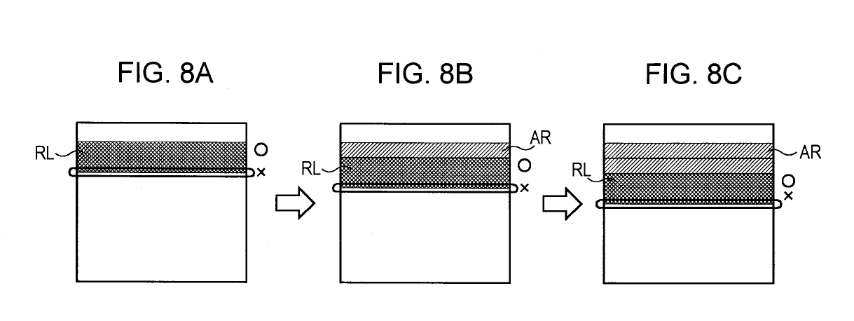

The deblocking filter executes deblocking-filter processing by referring to two adjacent pixels at a time (i.e., four pixels). Thus, as shown in FIGS. 8A to 8C, in the refresh line RL, an error propagates in two pixels from the refresh boundary BD. This is the third error-propagation cause.

The first to third propagation prevention systems are adapted to eliminate the first to third error-propagation causes and also to prevent the error propagation.

### 1-5. First Propagation Prevention System

### [1-5-1. Elimination of First Error Propagation Cause]

The video encoder 4 sets a search range so that no error propagation occurs, to thereby eliminate the first error-propagation cause.

In a case in which the encoding line unit is one macroblock line, when a search block with 16×16 pixels moves in the y direction by even a quarter pixel, the search block does not fit in the refresh line RL and thus the unreturned line UR is referred to. In this case, a search-range setting section 16 sets the motion-vector search range in only the x direction.

More specifically, the search-range setting section 16 checks the number of macroblock lines in the encoding line unit on the basis of the picture header. When the encoding line unit is one macroblock line, the search-range setting section 16 sets a motion vector MVy in the y direction to 0 and sets the search range in the x direction to “unlimited” value (i.e., a maximum value that is allowable in the x direction in the specifications) and supplies, to the motion predictor/compensator 14, a block that corresponds to the search range and that is to be referred to. The motion predictor/compensator 14 detects a motion vector in the search range with integer precision and supplies the detected motion vector to the search-range setting section 16.

Next, with respect to surrounding pixels of the motion vector detected with integer precision, the search-range setting section 16 generates half pixels and quarter pixels in only the x direction by using, for example, a 6-tap FIR filter and supplies the generated half pixels and quarter pixels to the motion predictor/compensator 14. The motion predictor/compensator 14 detects a motion vector in the x direction with quarter-pixel precision.

With this arrangement, the video encoder 4 excludes half pixels and quarter pixels in the y direction from the search range and thus can realize processing without inclusion of half pixels and quarter pixels that are adjacent to the refresh boundary BD and that correspond to two pixels. As a result, the video encoder 4 allows decoding to be performed without reference to error propagation pixels. Thus, it is possible to prevent error propagation in the returned line AR and it is also possible to eliminate the first error-propagation cause.

When the encoding line unit has two or more macroblock lines, the search-range setting section 16 sets the motion-vector search range so that the error propagation pixels are not referred to during decoding.

The video encoder 4 varies the position of the refresh line RL across pictures so that the refresh line RL is shifted downward, to thereby perform recovery from an error. Thus, error propagation pixels occur, in the refresh line RL, only at the lower side adjacent to the unreturned line UR. Accordingly, with respect to the lower side in the refresh line RL, the video encoder 4 sets the search range so that the error propagation pixels are not referred to.

More specifically, the search-range setting section 16 sets the search range in the range of the encoding line unit and supplies video corresponding to the set search range to the motion predictor/compensator 14. The motion predictor/compensator 14 detects a motion vector in the search range with integer precision and supplies the detected motion vector to the search-range setting section 16.

With respect to surrounding pixels of the motion vector detected with integer precision, the search-range setting section 16 generates half pixels and quarter pixels by using, for example, a 6-tap FIR filter. In this case, with respect to the area outside the three pixels from the refresh boundary BD, the search-range setting section 16 generates a block to be referred to so that neither half pixels nor quarter pixels are generated in the y direction, and supplies the generated block to the motion predictor/compensator 14.

In principle, the motion predictor/compensator 14 may detect a motion vector in the x and y directions with quarter-pixel precision. Since neither half pixels nor quarter pixels exist in the y direction with respect to the area outside the three pixels from the refresh boundary BD, the motion predictor/compensator 14 detects the motion vector with integer-pixel precision.

Thus, the video encoder 4 can prevent half pixels and quarter pixels outside the three pixels from the refresh boundary BD from being referred to during decoding and also can prevent prevention of an error resulting from the reference to the error propagation pixels.

As described above, the video encoder 4 is adapted so that it does not refer to pixels corresponding to error propagation pixels (i.e., half pixels and quarter pixels outside the three pixels from the refresh boundary BD) during detection of a motion vector. With this arrangement, the video decoder 32 can decode the inter-coded returned line AR without referring to the error propagation pixels. Thus, it is possible to prevent error propagation and it is possible to eliminate the first error-propagation cause.

### [1-5-2. Elimination of Second Error Propagation Cause]

When the video encoder 4 is adapted so that it does not refer to pixels other than the refresh line RL during intra prediction coding of the refresh line RL, it is possible to prevent propagation of an error from the unreturned line UR.

In H.264/AVC, during intra prediction coding, pixels in another slice are not referred to. In other words, the refresh line RL is placed at the front end in a slice and the intra coding is executed without reference to the unreturned line UR. With this arrangement, since the video decoder 32 can decode the refresh line RL without referring to the unreturned line UR, it is possible to prevent error propagation.

More specifically, the picture header has a flag indicating whether or not the front end of the refresh line RL is to be placed at the front end of a corresponding slice. The picture-header generator 9 (see FIG. 3) sets the flag to “true”. The intra-macroblock determining section 10 determines whether a macroblock to be processed is an I macroblock to be intra-coded or a P macroblock to be inter-coded.

The intra-macroblock determining section 10 determines that a macroblock corresponding to the refresh line RL that varies for each line is set as a forced intra macroblock, which is to be forcibly intra-coded. A macroblock belonging to the refresh line RL is hereinafter referred to as a “refresh macroblock”. A line constituted by macroblocks other than the macroblocks in the refresh line RL is referred to as an inter macroblock line.

On the other hand, the intra-macroblock determining section 10 determines whether or not a macroblock other than the macroblocks in the refresh line RL (i.e., a macroblock belonging to an inter macroblock line) is to be intra-coded as an I macroblock or is to be forward-inter-coded as a P macroblock.

The intra-macroblock determining section 10 predicts the amount of code generated for an I macroblock and a P macroblock and determines an encoding system with which the encoding efficiency is high. The result of the determination is supplied to the slice-division determining section 11.

When the flag indicating that the front end of the refresh line RL is to be placed at the front end in the slice is “true”, the current macroblock is a forced intra macroblock, and the refresh line RL Is at the front end, the slice-division determining section 11 determines that slice division is to be executed.

When it is predetermined that a picture is divided into multiple slices, the slice-division determining section 11 determines that slice division is to be executed, in accordance with the position of the macroblock to be processed. The result of the determination is supplied to the slice-header generator 12.

The slice-header generator 12 generates a slice header and adds the slice header to the front end of the current macroblock to generate a new slice. With respect to the macroblock at the front end in the slice, the intra predictor 15 executes intra coding by referring to, for example, a medium pixel value (“128” for pixel values of 0 to 255) and without referring to an inter macroblock line.

With this arrangement, the video encoder 4 can place the front end of the refresh line RL at the front end in the slice. Thus, since the video decoder 32 can decode the refresh line RL without referring to the unreturned line UR, it is possible to prevent error propagation.

As described above, by placing the refresh line RL at the front end in the slice, the video encoder 4 does not refer to an inter macroblock line in the refresh line RL. Thus, since the video decoder 32 can decode the refresh line RL without referring to the unreturned line UR, it is possible to prevent error propagation and to eliminate the second error-propagation cause.

In H.264/AVC, a flag constrained_intra_pred_flag is prepared. Setting the flag to “1” makes it possible to specify that inter-coded pixels are not referred to during intra coding. However, when the flag is set to “1”, inter-coded pixels are not referred to even in I macroblocks other than the forced intra macroblock. This arrangement, therefore, has a shortcoming of a reduced encoding efficiency.

More specifically, the picture-header generator 9 in the video encoder 4 sets constrained_intra_pred_flag in a PPS (picture parameter set) in the picture header to “1”. The flag set to “1” indicates that inter-coded pixels are not referred to during intra coding.

Upon checking that constrained_intra_pred_flag is “1”, the intra predictor 15 executes intra prediction processing by referring to only intra-coded pixels. As a result, since the video decoder 32 can decode the video data S4 by referring to only the intra-coded pixels, it is possible to prevent propagation of an error from the unreturned line UR.

As described above, by setting constrained_intra_pred_flag to “1”, the video encoder 4 can prevent propagation of an error from the unreturned line UR and can eliminate the second error-propagation cause.

### [1-5-3. Elimination of Third Error Propagation Cause]

As described above, when a deblocking filter is used, pixels in the unreturned line UR affect two pixels (hereinafter referred to as “boundary pixels”) from the refresh boundary BD during decoding of the refresh line RL. Consequently, the boundary pixels are broken. Thus, the video encoder 4 does not employ a deblocking filter.

More specifically, the slice-header generator 12 in the video encoder 4 sets disable_deblocking_filter_idc to “1”. The deblocking filter 26 checks disable_deblocking_filter_idc. When this flag is set to “1”, the deblocking filter 26 does not execute deblocking-filter processing on the corresponding slice.

Thus, since the video decoder 32 can decode the refresh line RL without executing the deblocking-filter processing on the refresh line RL, it is possible to prevent error propagation.

As described above, since the video encoder 4 does not employ a deblocking filter, it is possible to prevent the influence of the pixels in the unreturned line UR from breaking the boundary pixels in the refresh line RL and it is also possible to eliminate the third error-propagation cause.

### 1-6. Second Propagation Prevention System

In the second propagation prevention system, deblocking-filter processing is executed so as to improve the image quality of a propagation-prevention bit stream S6b.

### [1-6-1. Elimination of Third Error Propagation Cause]

### [1-6-1-1. Overlapped Appearance of Refresh Line]

As described above, when the deblocking-filter processing is executed, the boundary pixels constituted by two pixels from the refresh boundary BD are affected by the unreturned line UR and thus are broken. In the present embodiment, disable_deblocking_filter_idc is set to “2”. The flag set to “2” indicates that the deblocking-filter processing is not performed on the slice boundary. That is, when the flag is set to “2”, the video encoder 4 can execute the deblocking-filter processing on an area other than the slice boundary, making it possible to reduce noise induced by deblocking.

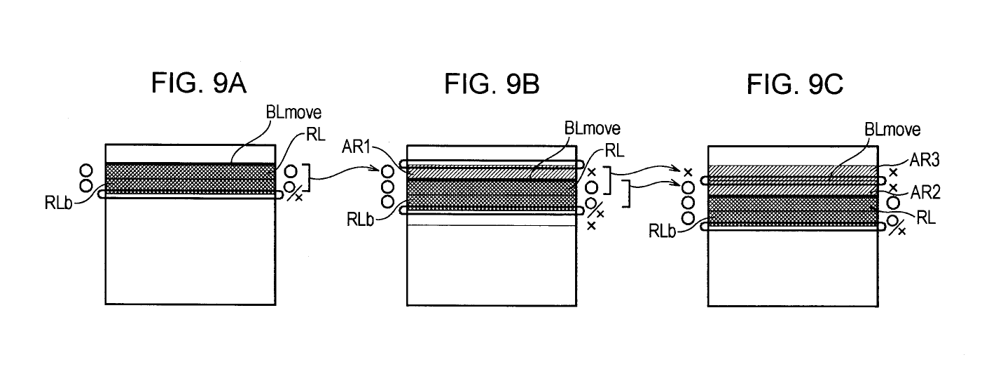

As shown in FIG. 9A, in the second propagation prevention system, the video encoder 4 constitutes the refresh line RL with multiple macroblock lines and divides the front end of the refresh line RL into slices. In this case, the macroblock line at the refresh boundary BD located at the lowermost in the refresh line RL (this macroblock line is hereinafter referred to as a “boundary MB line RLb”) is affected by the unreturned line UR as a result of the deblocking-filter processing.

However, the macroblock line(s) other than the boundary MB line RLb can be properly returned without being affected by the unreturned line UR. In the figure, pixels broken by the influence of the unreturned line UR are surrounded by a line for illustration.

As shown in FIGS. 9B and 9C, the video encoder 4 varies the position of the refresh line RL while causing the refresh line RL to overlap at least one macroblock line so that the boundary MB line RLb in the previous picture becomes the refresh line RL again in the next picture. That is, the intra-macroblock determining section 10 causes the refresh line RL having two or more block lines to appear with one macroblock line being shitted downward for each picture.

With this arrangement, although the boundary MB line RLb is broken by the deblocking-filter processing in a previous picture, the video encoder 4 can return the boundary MB line RLb in a next picture.

### [1-6-2. Slice Division]

A slice boundary whose position varies as in the case of the first propagation prevention system will hereinafter be referred to as a “slice boundary BLmove”. Now, attention is given to a case in which deblocking-filter processing is executed on an area other than the slice boundary BLmove. In FIGS. 9A to 9C, success and failure of recovery from an error when the influence of the deblocking-filter processing is not considered are indicated by “◯” and “x” on the left side and success and failure of decoding (recovery from an error) when the influence of the deblocking-filter processing is considered are indicated by “◯” and “x” on the right side.

As shown in FIG. 9A, the refresh line RL is decoded without any problem by the intra prediction processing. In the boundary MB line RLb, however, the adjacent pixels are broken by the deblocking-filter processing. As shown in FIGS. 9A and 9B, when the deblocking-filter processing is executed, the broken adjacent pixels are referred to and thus an error propagates. This makes it difficult to recover from the error.

The video encoder 4 in the second propagation prevention system fixes the slice boundary as a slice boundary BLfix.

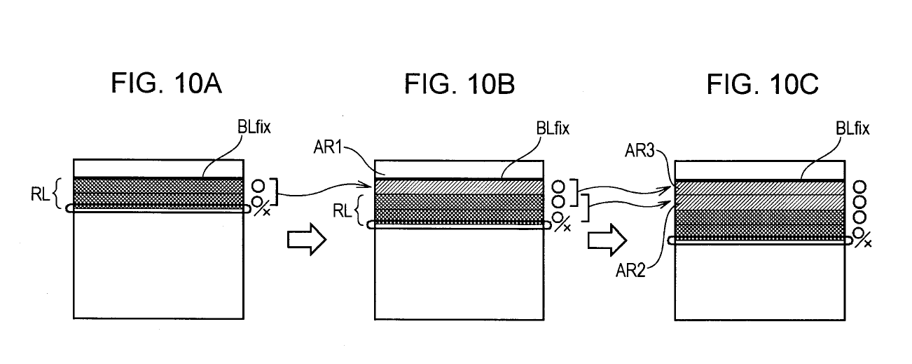

As shown in FIG. 10A, the refresh line RL is decoded without any problem by the intra prediction processing. In the boundary MB line RLb, however, the boundary pixels are broken by the deblocking-filter processing.

As shown in FIG. 10B, since the slice boundary BLfix does not move, the front end in the slice becomes a returned line AR1. The returned line AR1 is decoded without any problem through reference to the refresh line RL and the range in which no error propagates in the boundary MB line RLb. Since the returned line AR1 is located at the slice boundary BLfix, the deblocking-filter processing is not executed on the boundary between the returned line AR1 and the unreturned line UR. Consequently, with respect to the returned line AR1, it is possible to recover from the error without breaking of the boundary pixels. As shown in FIG. 100, the same applies to a next picture and the error does not propagate in the next picture.

In the second embodiment, since the error recovery is started after the refresh line RL is placed at the front end in the slice, 2T−1 is taken for the error recovery and thus a little more time is taken than the time taken in the first embodiment.

### [1-6-3. Elimination of Second Error Propagation Cause]

As described above, the video encoder 4 in the second embodiment does not place the front end of the refresh line RL at the front end in the slice. However, since the slice boundary BLfix is fixed as shown in FIGS. 10A to 10C, an inter-coded line between the slice boundary BLfix and the refresh line RL returns.

That is, an inter-coded line that is likely to be referred to by the refresh line RL is already returned, and thus, even when the inter-coded line is used as the block to be referred to, no particular problem arises.

### [1-6-4. Elimination of First Error Propagation Cause]

In this case, according to the video encoder 4, in the boundary MB line RLb, only the two boundary pixels adjacent to the unreturned line UR are broken by the deblocking-filter processing. Accordingly, the video encoder 4 sets, as the motion-vector search range, pixels that are included in the boundary MB line RLb and that are unaffected by the unreturned line UR, in addition to the encoding line unit in the previous picture.

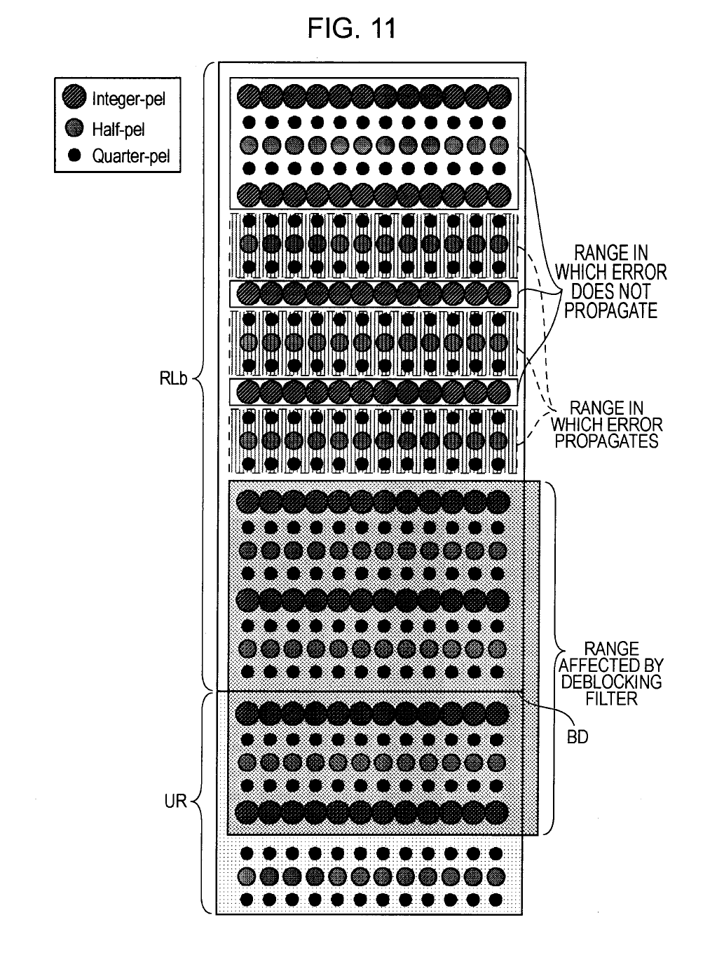

As shown in FIG. 11, in the boundary MB line RLb, the boundary pixels are broken by the influence of the unreturned line UR. Thus, because of the influence of the unreturned line UR, half pixels and quarter pixels generated with reference to the boundary pixels become error propagation pixels in which an error propagates. Thus, the video encoder 4 sets, as the motion-vector search range, the area excluding the boundary pixels and the error propagation pixels.

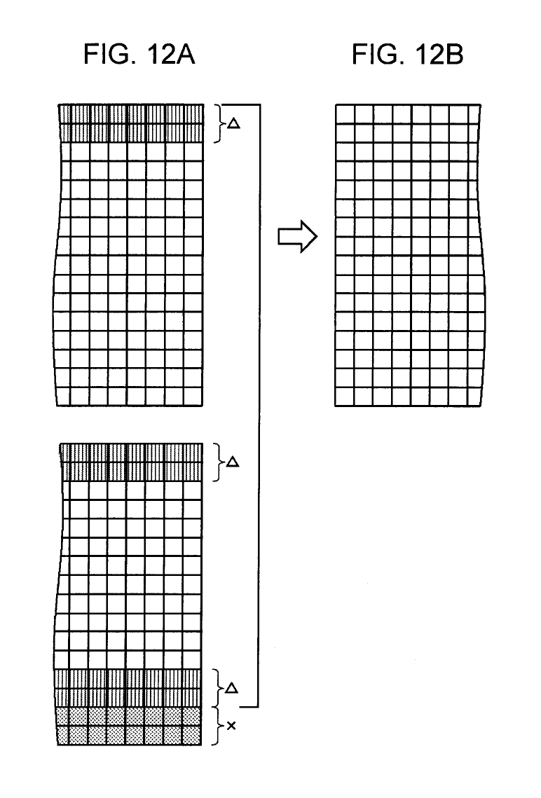

That is, as shown in FIG. 12A, with respect to the encoding line unit (shown in FIG. 12B) of a next picture to be processed, the search-range setting section 16 in the video encoder 4 sets, as a y-direction search range, a corresponding encoding line unit (excluding the error-propagation pixels at the upper side) in a previous picture. The search-range setting section 16 further sets, as a y-direction search range of the motion vector, a portion of an encoding line unit located immediately below a corresponding encoding line unit in a previous picture. The portion of the encoding line unit is a range excluding the error-propagation pixels at the upper side and the boundary pixels and the error propagation pixels at the lower side.

As described above, in the second propagation prevention system, the video encoder 4 is adapted to prevent error propagation during decoding while improving the image quality by executing the deblocking-filter processing.

### 1-7. Third Propagation Prevention System

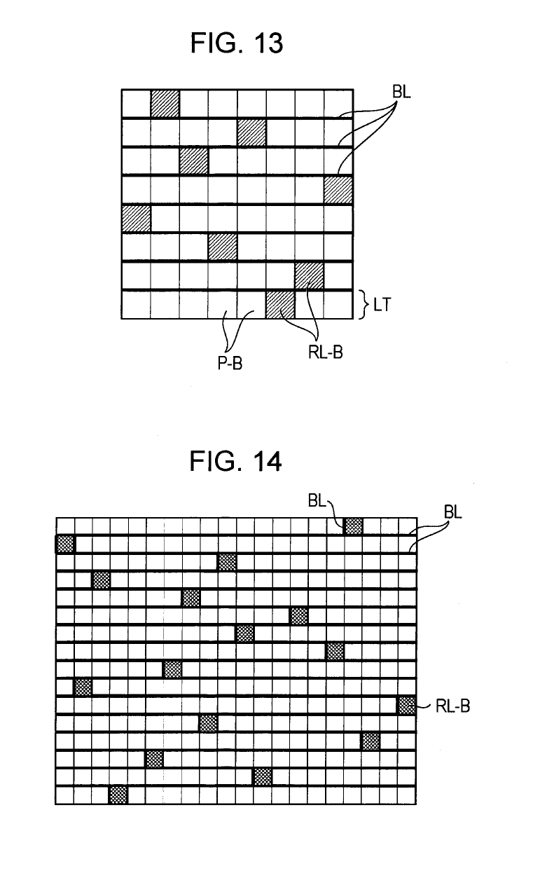

As shown in FIG. 13, in the third propagation prevention system, a picture is divided into multiple encoding block units and an enforced intra macroblock is determined for each encoding block unit. That is, in the present embodiment, error recovery is performed for each refresh block RL-B rather than for each refresh line RL.

The refresh block RL-B is constituted by an arbitrary number of macroblocks. That is, the refresh macroblock RL-B may be constituted by multiple macroblocks, for example, 4×4 macroblocks or 8×8 macroblocks or may be constituted by a single macroblock.

In the third propagation prevention system, a slice is formed for each row in which the encoding block unit is arranged. A predetermined number of refresh blocks RL-B appear in the slice. Thus, in the present embodiment, the amount of code for each slice can be made constant. This slice will hereinafter be referred to as a “constant-code-amount slice LT”.

Thus, in the third propagation prevention system, the amount of delay caused by buffering during wireless transmission can be reduced to an amount corresponding to the constant-code-amount slice LT.

In the third propagation prevention system, the refresh block RL-B is caused to appear for each encoding block unit. Although the refresh block RL-B appears periodically, i.e., at a cycle T, in each constant-code-amount slice LT, the relationship between the refresh blocks RL-B across the constant-code-amount slices LT has no certain rule. That is, the refresh blocks RL-B appear as if they were random.

In general, intra-coded I macroblocks have a higher image quality than inter-coded P macroblocks. In the first and second embodiments, since the forced intra macroblock appears for each refresh line RL, the difference in the image quality between the forced intra macroblock and the P macroblock becomes prominent.

In the third propagation prevention system, the forced intra macroblock is caused to appear for each relatively small encoding block unit to thereby make it possible to make the difference in the image quality between the I macroblock and the P macroblock less prominent and also to make it possible to improve the image quality of the picture.

### [1-7-1. Refresh for Each Macroblock]

A description in the present embodiment will be given of a case in which the refresh block RL-B is constituted by a single macroblock.

As shown in FIG. 14, the video encoder 4 forms a constant-code-amount slice LT for each macroblock line and causes the refresh block RL-B to appear for each macroblock.

### [1-7-2. Elimination of First Error Propagation Cause]

The search-range setting section 16 in the video encoder 4 sets the search range to “0” in both x and y directions. That is, the motion predictor/compensator 14 does not execute motion-vector detection, so that the motion vector is “0”.

### [1-7-3. Elimination of Second Error Propagation Cause]

As in the case of the first embodiment, the video encoder 4 places the refresh macroblock RL-B at the front end in the slice to thereby prevent propagation of an error from an unreturned macroblock UM in the intra prediction processing.

When the refresh block RL-B is located at the left edge of the picture, the slice-division determining section 11 performs slice division in the middle of the same macroblock line (e.g., immediately after the refresh block RL-B). With this arrangement, the slice-division determining section 11 can constantly constitute the constant-code-amount slice LT with two slices.

### [1-7-4. Elimination of Third Error Propagation Cause]

The slice-header generator 12 sets disable_deblocking_filter_idc to “1” to generate a slice header. Upon checking the flag, the deblocking filter 26 does not execute deblocking-filter processing.

As described above, in the third propagation prevention system, the video encoder 4 is adapted to prevent error propagation during decoding while improving the image quality by causing a forced intra macroblock to appear for each macroblock unit.

### 1-8. Detection of Error

### [1-8-1. Mode Switching Due to Packet Loss]

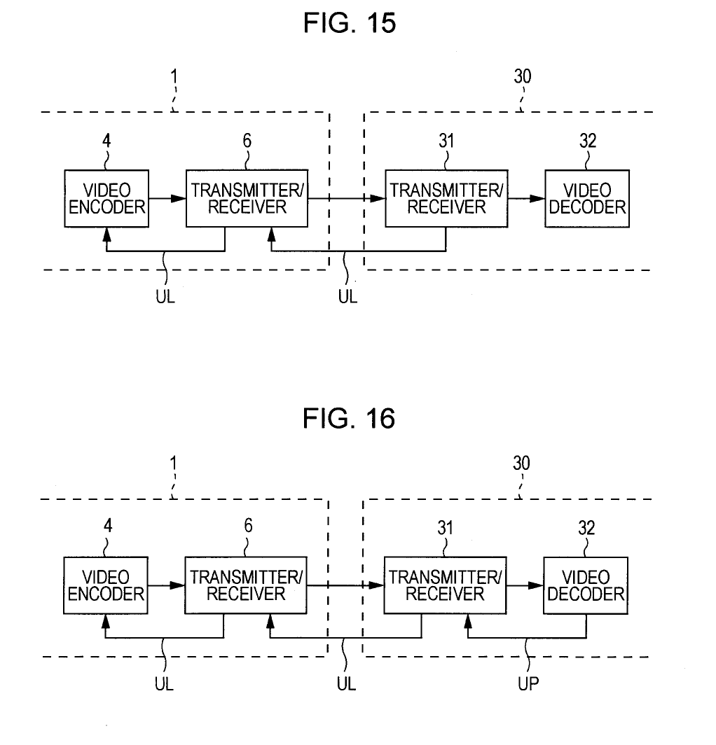

The transmitter/receiver 6 in the video processing apparatus 1 transmits the bit stream S6 in the form of packets to the transmitter/receiver 31 in the display apparatus 30. Upon receiving the packets, the transmitter/receiver 31 recognizes an un-received packet, on the basis of identifiers (IDs) added to the packets. The transmitter/receiver 31 issues a request to the transmitter/receiver 6 so as to retransmit the un-received packet. When the un-received packet is not received even when the retransmission request is repeatedly issued a predetermined number of times, the transmitter/receiver 31 transmits uplink information UL indicating error to the transmitter/receiver 6, as shown in FIG. 15.

In addition, upon receiving the packets, the transmitter/receiver 31 also verifies the validity of the packets. When the packets have no validity, the transmitter/receiver 31 transmits uplink information UL indicating error to the transmitter/receiver 6.

In this case, the transmitter/receiver 31 is not able to identify the position of the error in the bit stream S6. Thus, the transmitter/receiver 31 supplies, to the transmitter/receiver 6, uplink information UL in which an error flag indicating error is set to “true”.

The transmitter/receiver 6 supplies the uplink information UL to an encoding-mode switching section 29 in the video encoder 4. Upon recognizing detection of an error due to packet loss on the basis of the uplink information UL, the encoding-mode switching section 29 switches the encoding mode from the normal encoding mode to the propagation-prevention encoding mode. In this case, the encoding-mode switching section 29 executes the propagation-prevention encoding mode on the entire area of the picture. The propagation-prevention encoding mode executed on the entire area of the picture will hereinafter be referred to as an “entire-area propagation prevention mode”.

When encoding is executed during a recovery period TA in which intra macroblocks appear in the entire area of the picture, the encoding-mode switching section 29 recognizes that recovery from the error is completed and switches the encoding mode to the normal encoding mode.

As in the manner described above, when an error due to packet loss is detected, the video processing system 100 is adapted to enter the entire-area propagation prevention mode during the recovery period TA until recovery from the error is completed. In the first and third error propagation prevention systems, the recovery period TA is equal to the cycle T, and in the second error propagation prevention system, the recovery period TA is expressed by 2×“cycle T”−1.

### [1-8-2. Mode Switching due to Partial Error in Data]

In packet loss detection performed by the transmitter/receiver 31, an undetectable error may exist. Accordingly, the display apparatus 30 detects an error undetected by the transmitter/receiver 31, by using the error detector 43 (FIG. 4).

As described above, the video decoder 32 decodes the bit stream S6 in accordance with the CAVLC system or CABAC system. In the CAVLC system, data is decoded through data comparison with a table. Thus, an error can be detected through detection of a solution-less combination or an unlikely combination (i.e., detection of a syntax error).

However, since arithmetic coding is used in the CABAC system, there are cases in which processing continues with an error undetected. Thus, according to the video processing system 100, a rule is predetermined between the video encoder 4 and the video decoder 32 so that, when a value that deviates from the rule is detected, it is recognized that an error occurred.

More specifically, during encoding, the video encoder 4 restricts the use of a value or values that seem to be rarely used out of values specified in the H.264/AVC standard and executes encoding without use of the values. Upon detecting the restricted value, the error detector 43 recognizes that an error occurred.

For example, the video encoder 4 restricts a maximum value of a motion vector, restricts a minimum value of a block size for motion compensation, restricts a maximum value (quantum Δ) of a difference value of quantization parameters QP between macroblocks, restricts a range in which a macroblock mode (for I pictures, P pictures, and so on) is allowed, or restricts a range in which a direction in the intra prediction is allowed. Only one of those restrictions may be executed or any combination of the restrictions maybe used.

Thus, the error detector 43 executes error detection processing in accordance with an error detection program. The error detector 43 monitors the reversible-decoding section 42. Upon detecting inconsistency in syntax or upon detecting a value that should not be used by the restriction, the error detector 43 recognizes that an error occurred.

In this case, as shown in FIG. 16, the error detector 43 transmits error position information UP to the transmitter/receiver 31. The transmitter/receiver 31 sets an error flag indicating error to “true” and supplies, to the transmitter/receiver 6, uplink information UL to which the error position information UP is added.

The transmitter/receiver 6 supplies the uplink information UL to the encoding-mode switching section 29 in the video encoder 4. Since the error position information UP is added to the uplink information UL, the encoding-mode switching section 29 recognizes that an error due to partial error of data is detected.

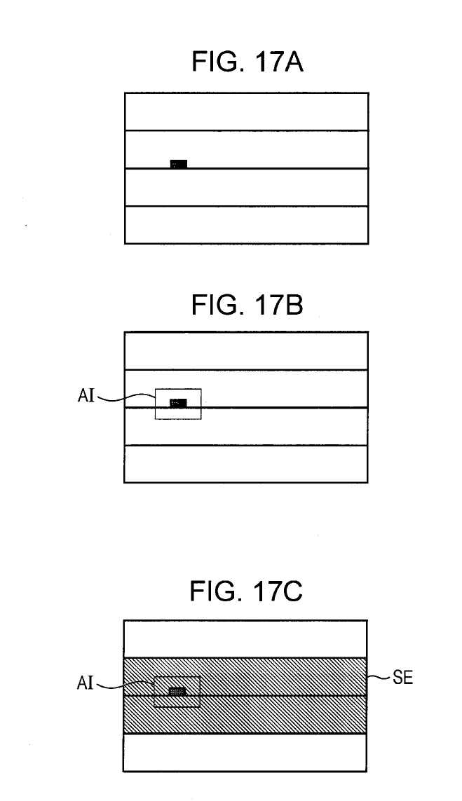

On the basis of the error position information UP, the encoding-mode switching section 29 identifies an error propagation range in which the error can propagate. A case in which one picture is divided into four slices, as shown in FIGS. 17A to 17C, will now be described by way of example.

As described above, in the intra prediction processing, pixels at another slice are not referred to. Thus, an error resulting from the intra prediction processing can propagate in the entire area of a macroblock that is included in the slice and is temporally subsequently processed.

In the normal encoding mode, the motion-vector reference range is predetermined in the motion compensation/prediction processing. Thus, in a picture next to a picture in which an error appeared, the error can propagate to the motion-vector reference range. In addition, in a picture after the next one of the picture in which the error appeared, the error with respect to a reference range in the next one of the picture in which the error appeared can propagates to a reference range. That is, as the more rearward the picture is, the larger an error propagation range AI in which the error propagates becomes.

On the basis of the state of supplied packets, the encoding-mode switching section 29 locates the position of each picture in the video data S4 to be encoded and identifies an error propagation range AI (see FIG. 17B) in the picture.

The encoding-mode switching section 29 identifies a slice or slices (two slices in the illustrated example) including the error propagation range AI as error propagation slices SE and executes encoding in the propagation-prevention encoding mode on the error propagation slices SE. With respect to slices other than the error propagation slices SE, encoding in the normal encoding mode is executed. The propagation-prevention encoding mode executed on a partial area in a picture, in a manner as described above, will hereinafter be referred to as a “partial-area propagation prevention mode”.

The encoding-mode switching section 29 executes encoding in the partial-area propagation prevention mode on the error propagation slices SE during an error-slice recovery period TEN in which error recovery is completed. When one picture is divided into four slices, the slice recovery period TE for each of the error propagation slices SE in the first and third error propagation prevention systems is given by “cycle T”×¼ and the slice recovery period TE for each error propagation slice SE in the second propagation prevention system is given by (2×“cycle T”−1)×¼.

The encoding-mode switching section 29 executes encoding in the partial-area propagation prevention mode during the error-slice recovery period TEN given by multiplying the slice recovery period TE by the number “N” of error propagation slices SE. With this arrangement, in the partial-area propagation prevention mode, the encoding-mode switching section 29 can reduce the period until recovery from an error is completed, compared to a case in the entire-area propagation prevention mode.

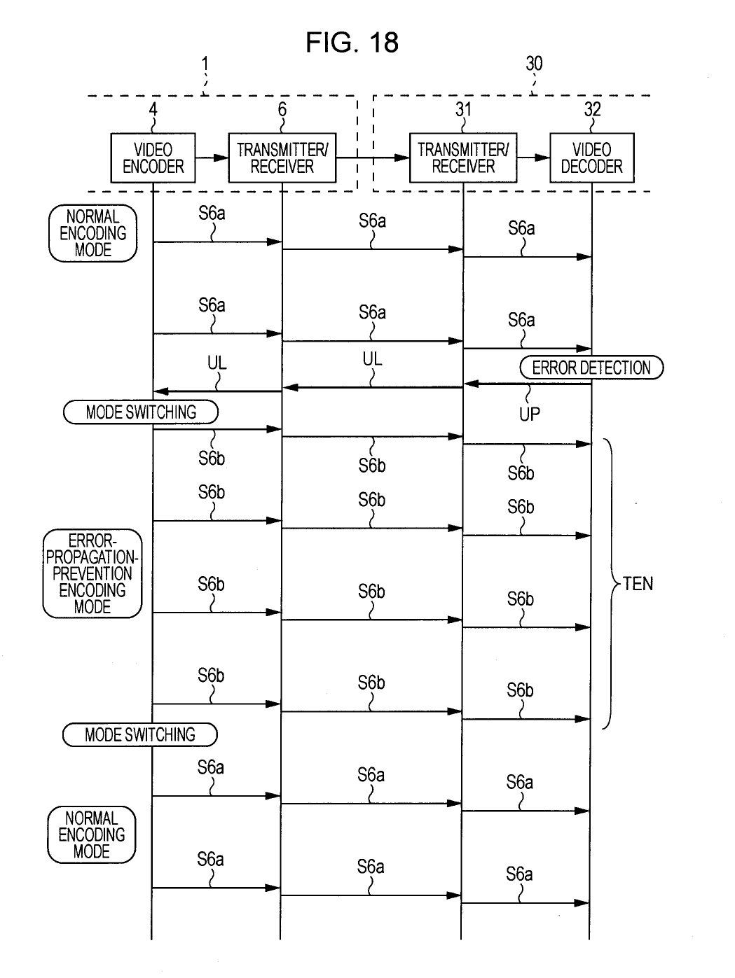

That is, as shown in FIG. 18, during normal operation, the video encoder 4 executes encoding in the normal encoding mode and supplies a normal encoded bit stream 6a to the video decoder 32 via the transmitter/receiver 6 and the transmitter/receiver 31. When an error is detected from the data, the video decoder 32 supplies the error position information UP to the transmitter/receiver 31.

The transmitter/receiver 31 generates uplink information UL including the error position information UP and supplies the resulting uplink information UL to the video encoder 4 via the transmitter/receiver 6. The video encoder 4 identifies an error propagation range AI in which the error propagates to a block to be processed and to be encoded. The video encoder 4 then enters the partial-area propagation prevention mode to switch the encoding mode to the propagation-prevention encoding mode with respect to a range including the identified error propagation range AI and to switch the encoding mode to the normal encoding mode with respect to a range that does not include the error propagation range AI.

The encoding-mode switching section 29 then executes the partial-area propagation prevention mode during the error-slice recovery period TEN to generate a propagation-prevention encoded stream S6b and supplies the propagation-prevention encoded stream S6b to the video decoder 32 via the transmitter/receiver 6 and the transmitter/receiver 31. The video encoder 4 then enters the normal encoding mode to return to the normal encoding processing and supplies a normal encoded bit stream 6a to the video decoder 32 via the transmitter/receiver 6 and the transmitter/receiver 31.

With this arrangement, it is sufficient for the video encoder 4 to partially execute the propagation-prevention encoding mode, thus making it possible to reduce a range to be refreshed in the picture and also making it possible to reduce the amount of time taken for error recovery.

### 1-9. Processing Procedure

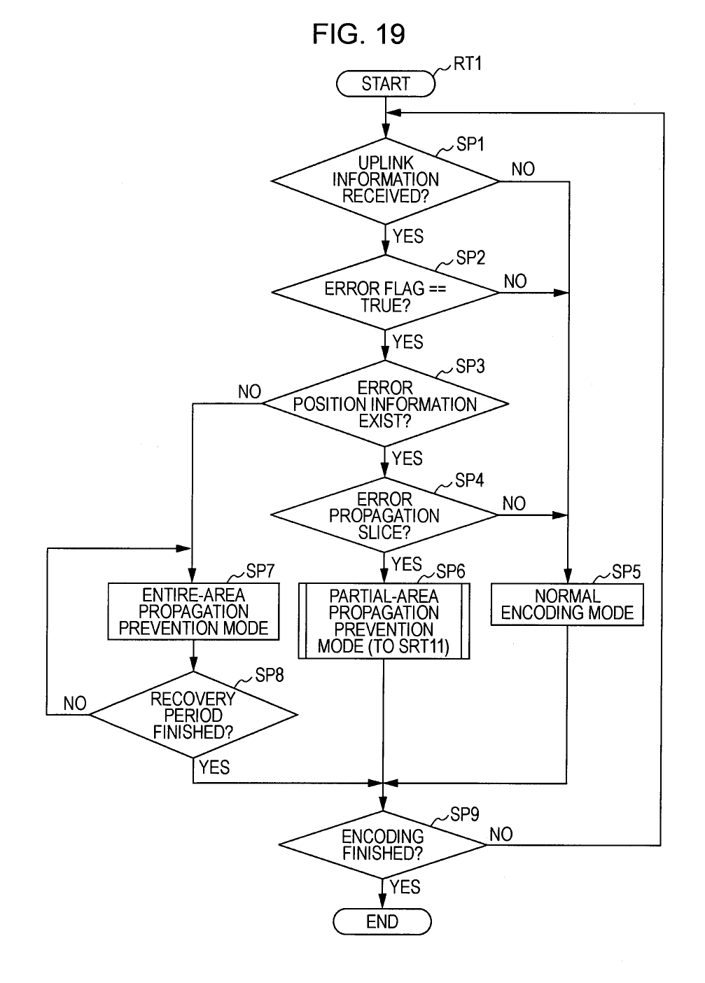

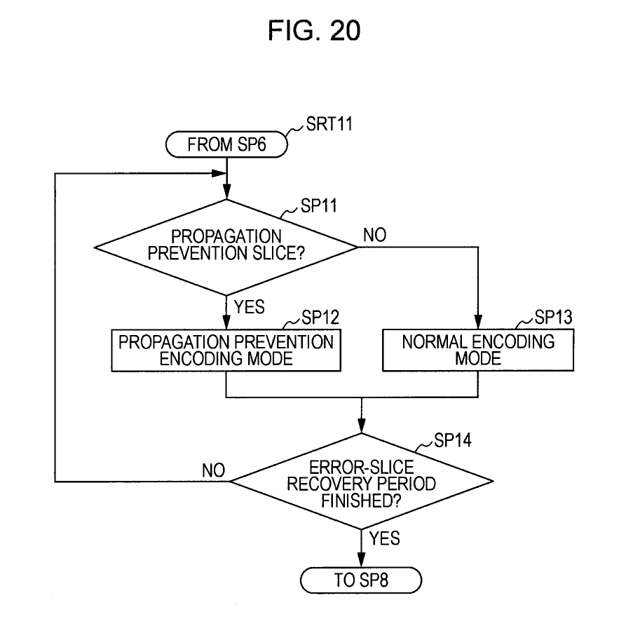

Next, an encoding processing procedure RT1 executed in accordance with an encoding program will now be described with reference to a flowchart shown in FIG. 19.

When the video encoder 4 starts encoding processing, the process proceeds to step SP1 in which a determination is made as to whether or not uplink information UL is received.

When a negative result (i.e., NO) is obtained, this means that no error is detected and the normal encoding mode is to be maintained. In this case, the process of the video encoder 4 proceeds to step SP5.

On the other hand, when an affirmative result (i.e., YES) is obtained in step SP1, there is a possibility that an error is detected and the process of the video encoder 4 proceeds to step SP2. In step SP2, the video encoder 4 determines whether or not the error flag indicates “true”.

When a negative result is obtained in step SP2, this means that no error is detected and the normal encoding mode is to be maintained. In this case, the process of the video encoder 4 proceeds to step SP5.

In step SP5, the video encoder 4 maintains the normal encoding mode or enters the normal encoding mode. When the video encoder 4 executes encoding processing in the normal encoding mode, the process proceeds to step SP9.

On the other hand, when an affirmative result is obtained in step SP2, this means that an error is detected and the process of the video encoder 4 proceeds to step SP3. In step SP3, the video encoder 4 determines whether or not error position information UP exists.

When a negative result is obtained in step SP3, this means that the detected error is due to packet loss and the position at which the error occurred is unidentifiable. In this case, the process of the video encoder 4 proceeds to step SP7.

In step SP7, the video encoder 4 switches the encoding mode to the entire-area propagation prevention mode. When the video encoder 4 executes encoding processing in the propagation-prevention encoding mode, the process proceeds to step SP8.

In step SP8, the video encoder 4 determines whether or not the recovery period TA is finished. When a negative result is obtained in step SP8, the process returns to step SP7 and the video encoder 4 continuously performs the encoding processing in the propagation-prevention encoding mode until the recovery period TA is finished.

On the other hand, when an affirmative result is obtained in step SP8, the process of the video encoder 4 proceeds to step SP9.

When an affirmative result is obtained in step SP3, this means that the detected error is error detected from data and the position at which the error occurred is identifiable. In this case, the process of the video encoder 4 proceeds to step SP6.

In step SP6, the video encoder 4 proceeds to step SP11 in a subroutine SRT11 representing a processing procedure of the partial-area propagation prevention mode. In step SP11, the video encoder 4 determines whether or not the block to be processed belongs to a propagation prevention slice SE.

When an affirmative result is obtained in step SP11, the process proceeds to step SP12 in which the video encoder 4 executes encoding processing in the propagation-prevention encoding mode. Thereafter, the process proceeds to step SP14.

On the other hand, when a negative result is obtained in step SP11, the process proceeds to step SP13 in which the video encoder 4 executes encoding processing in the normal encoding mode. Thereafter, the process proceeds to step SP14.

In step SP14, the video encoder 4 determines whether or not the error-slice recovery period TEN is finished. When a negative result is obtained in step SP14, the process returns to step SP11 and the video encoder 4 continuously performs the encoding processing in the partial-area propagation-prevention encoding mode.

On the other hand, when an affirmative result is obtained in step SP14, the process of the video encoder 4 proceeds to step SP9 in the encoding processing procedure RT1 (in FIG. 19).

In step SP9, the video encoder 4 determines whether or not the encoding processing on the video data S4 is finished. When a negative result is obtained, the process returns to step SP1 and the video encoder 4 continuously performs the encoding processing procedure RT1. On the other hand, when an affirmative result is obtained in step SP9, the process proceeds to an “end” step in which the video encoder 4 ends the encoding processing procedure RT1.

The above-described encoding processing may be executed by a hardware configuration or may be executed by software. When the encoding processing is executed by software, the video encoder 4 is virtually configured by a computing unit, such as a CPU (central processing unit). The same applies to the above-described error detection processing executed by the video decoder 32.

### 1-10. Operation and Advantages

With the above-described configuration, with respect to a block to be referred to (which is an reference encoding unit in a reference picture to be referred to), the video processing apparatus 1 that serves as video transmitting apparatus performs filter processing involving adjacent pixels to generate pixels (pixels with sub-integer precision, which hereinafter may be referred to as “correspondent pixels”) corresponding to the adjacent pixels. The video processing apparatus 1 sets a search range for the block to be referred to; detects, in the set search range, a motion vector for a local decoded image L4 obtained through the deblocking filter 26; and then executes motion prediction processing.

The video processing apparatus 1 sets deblocking-filter setting information indicating whether deblocking-filter processing is to be applied or deblocking-filter processing is to be applied to the refresh boundary BD (which is a boundary line). In accordance with the deblocking-filter setting information, the video processing apparatus 1 executes the deblocking-filter processing on a local decoded image L3 of the encoded block to be processed (which is an encoding unit).

The video processing apparatus 1 transmits, to the display apparatus 30 serving as a video receiving apparatus, the bit stream S6 subjected to the motion prediction processing. The video processing apparatus 1 receives, from the display apparatus 30, the uplink information UL in which the error flag is set (i.e., is “true”) as error information indicating that an error was detected.

During normal operation, the video processing apparatus 1 selects the normal encoding mode as the encoding mode, and also executes intra coding on an enforced intra block upon receiving the uplink information UL in which the error flag is set. In this case, the video processing apparatus 1 selects the propagation-prevention encoding mode as the encoding mode. In the propagation-prevention encoding mode, the video processing apparatus 1 sets a search range for the block to be referred to so that the search range does not include the sub-integer-precision correspondent pixels from the refresh boundary BD serving as a boundary between the forced intra block and another block, the correspondent pixels corresponding to the number of adjacent pixels. By making a change to the deblocking-filter setting information, the video processing apparatus 1 sets a restriction on the deblocking-filter processing.

With this arrangement, during normal operation in which no error is detected, the video processing apparatus 1 can execute encoding processing in the normal encoding mode. Thus, it is possible to improve the encoding efficiency of the bit stream and it is also possible to improve the image quality of the bit stream at the same communication speed.

When the recovery period TA or the error-slice recovery period TEN, which is an error recovery period for error recovery, is finished, the video processing apparatus 1 switches the encoding mode to the normal encoding mode.

With this arrangement, immediately after recovery from the error, the video processing apparatus 1 can enter the normal encoding mode in which the image quality is favorable. Thus, it is possible to minimize the time taken until the video processing apparatus 1 enters the error-propagation prevention mode and it is possible to maximize the image quality of the reproduced video data S14.

In the normal encoding mode, the video processing apparatus 1 executes encoding involving only the forward prediction coding (for P macroblocks).

With this arrangement, the video processing apparatus 1 improves the encoding efficiency in the normal encoding mode, thus making it possible to improve the image quality of the bit stream S6.

When the position of an error in the bit stream S6 can be located, the video processing apparatus 1 applies the propagation-prevention encoding mode to the error propagation prevention area (i.e., the error propagation slice(s) SE) including the error propagation range AI in which the error can propagate.

With this arrangement, the video processing apparatus 1 can reduce the range to which the propagation-prevention encoding mode is applied and can reduce the amount of time taken until error recovery is completed.

The video processing apparatus 1 identifies the error propagation slice(s) SE on the basis of the error position information UP that is added to the uplink information UL and that indicates the error position. Thus, on the basis of the error position, the video processing apparatus 1 can applies the propagation-prevention encoding mode to an error propagation prevention area that is advantageous for the video processing apparatus 1.

The video processing apparatus 1 switches the encoding mode for each predetermined slice. With this arrangement, since the video processing apparatus 1 performs slice division on only a predetermined slice, it is possible to achieve encoding processing without unnecessarily dividing a slice and without causing an unwanted encoding-efficiency decrease due to slice division.

When the position of the error in the bit stream S6 is unidentifiable, the video processing apparatus 1 enters the entire-area propagation prevention mode and applies the propagation-prevention encoding mode to the entire area of the picture.

With this arrangement, even when the error position information UP is not present and the error position is unidentifiable, the video processing apparatus 1 can enter the propagation-prevention encoding mode to recover from the error.

The video processing apparatus 1 selects one of the first to third propagation prevention systems as the propagation-prevention encoding mode, in accordance with the speed of communication between the video processing apparatus 1 and the display apparatus 30 serving as a video receiving apparatus.

With this arrangement, since the video processing apparatus 1 can select the appropriate propagation prevention system corresponding to the communication speed, a decrease in the image quality in the video data S14 to be reproduced can be minimized even when the video processing apparatus 1 enters the propagation prevention mode.

The video encoder 4 in the video processing apparatus 1 receives the video data S4 and encodes the video data S4 by intra coding and forward inter coding. In this case, the video encoder 4 assigns macroblocks (which are encoding units) to forced intra blocks or blocks (inter blocks) other than the forced intra blocks so that, at a constant cycle T, all the macroblocks in the picture become forced intra blocks to be intra-coded.

With this arrangement, the video encoder 4 can reliably recover the video data S4 from an error during the recovery period TA corresponding to the cycle T or the error-slice recovery period TEN.

The display apparatus 30 receives the bit stream S6, which is obtained by encoding the video data S4 including multiple pictures and is transmitted from the video processing apparatus 1, and performs reversible decoding on the bit stream S6.

Upon detecting the value that deviates from the rule predetermined with the video processing apparatus 1, the display apparatus 30 recognizes that an error occurred and thereby detects an error from the reversible-decoded bit stream S6 (i.e., macroblock data in the quantized coefficients D3). Upon detecting an error, the display apparatus 30 adds the error position information UP indicating the position at which the error was detected to the uplink information UL indicating that error was detected and transmits the resulting uplink information UL to the video processing apparatus 1.

The value(s) that deviates from the predetermined rule may be values having a low use frequency. Thus, the video processing system 100 restricts the use of values that do not deviate from the standard and that have a small influence on the image quality. Thus, the video processing system 100 can minimize the influence on the image quality, the influence resulting from provision of the rule in a range that does not deviate from the standard.

The display apparatus 30 performs reversible decoding on the bit stream S6 in accordance with the CABAC system. Thus, the display apparatus 30 can appropriately detect even an error that is undetectable during the reversible decoding, by recognizing the value that deviates from the predetermined rule as an error.

The display apparatus 30 detects loss of packets in the bit stream S6. In response to packet loss, the display apparatus 30 transmits, to the video processing apparatus 1, the uplink information UL indicating that an error was detected. With this arrangement, upon detecting packet loss, the display apparatus 30 can quickly supplies the uplink information UL to the video processing apparatus 1. As a result, the video processing apparatus 1 can quickly enters the propagation-prevention encoding mode, thus making it possible to recover from the error in the video data S14 earlier.

More specifically, during start of communication, the video processing apparatus 1 determines the communication rate by transmitting/receiving data to/from the display apparatus 30. When the communication rate is low, the video processing apparatus 1 selects the first propagation prevention system. When the communication rate is about medium, the video processing apparatus 1 selects the second propagation prevention system, which can improve the image quality compared to the first propagation prevention system. When the communication rate is high, the video processing apparatus 1 selects the third propagation prevention system, which provides a more favorable image quality than the first and second propagation prevention systems.

With this arrangement, the video processing apparatus 1 can select the propagation prevention system that provides a most favorable image quality at an allowable communication rate and thus can improve the image quality of the video data S14 when the video processing apparatus 1 enters the propagation-prevention encoding mode.

According to the configuration described above, upon recognizing that no error occurred in the error recognition step in which the presence/absence of an error is checked and in the error detection step, the video processing apparatus 1 enters the normal encoding mode, whereas, upon recognizing that an error occurred in the error detection step, the video processing apparatus 1 enters the propagation-prevention encoding mode.

Upon entering the normal encoding mode, the video processing apparatus 1 generates sub-integer-precision pixels corresponding to adjacent pixels by performing filter processing involving the adjacent pixels with respect to a block to be referred to in a reference picture and sets a search range for the block to be referred to. The video processing apparatus 1 detects, in the set search range, a motion vector for a local decoded image obtained through the deblocking filter and executes motion prediction processing. The video processing apparatus 1 sets deblocking-filter setting information indicating whether deblocking-filter processing is to be applied or deblocking-filter processing is to be applied to the boundary line. In accordance with the deblocking-filter setting information, the video processing apparatus 1 executes the deblocking-filter processing on a local decoded image L3 in the block that is encoded through the motion prediction processing and that is to be processed.

Upon entering the error-propagation prevention mode, the video processing apparatus 1 executes intra coding on an enforced intra block and generates sub-integer-precision pixels corresponding to adjacent pixels by performing filter processing involving the adjacent pixels with respect to a block to be referred to in a reference picture. The video processing apparatus 1 sets the search range for the block to be referred to so that the search range does not include correspondent pixels from the boundary line BL serving as a boundary between the enforced intra block and another block, the correspondent pixels corresponding to the number of adjacent pixels. The video processing apparatus then detects a motion vector in the set search range and executes motion prediction processing. The video processing apparatus 1 sets a restriction on the deblocking-filter processing by making a change to the deblocking-filter setting information, and in accordance with the changed deblocking filter setting information, the video processing apparatus 1 executes deblocking-filter processing on the local decoded image L3 of the block that is encoded through the motion prediction processing and that is to be processed.

The video processing apparatus 1 then transmits, to the video receiving apparatus, the bit stream subjected to the motion prediction processing.

With this arrangement, the video processing system 100 can prevent propagation of an error even in the encoding system (such as an H.264/AVC system) having many causes for error propagation and can quickly recover the video data S14 from the error. In addition, the video processing system 100 enters the propagation-prevention encoding mode, only upon detection of an error. Thus, the video processing system 100 can minimize the use frequency of the propagation-prevention encoding mode in which the image quality is likely to decrease since intra coding using a large amount of code is performed, and can improve the image quality of the video data S14. Accordingly, the present invention can realize a video transmitting apparatus, a video transmitting method, a video receiving apparatus, and a video receiving method which can improve the image quality.

### 2. Other Embodiments

The description in the first embodiment has been given of a case in which the video processing apparatus 1 identifies the error propagation range AI on the basis of the error position information UP supplied from the display apparatus 30. The present invention is not limited to this arrangement. For example, the arrangement may be such that the display apparatus 30 transmits, to the video processing apparatus 1, error information to which error propagation information indicating the error propagation range AI is added and the video processing apparatus 1 identifies the error-propagation prevention area in accordance with the error propagation information indicating the error propagation range AI.

The description in the above-described embodiment has been given of a case in which the propagation prevention system selected from the first to third propagation prevention systems is used for the propagation-prevention encoding mode to execute encoding. The present invention is not limited to this arrangement. For example, one propagation prevention system may be constantly executed as the propagation-prevention encoding mode or the propagation prevention system may be selected from two propagation prevention systems or four or more propagation prevention systems. The propagation-prevention encoding system may be determined in accordance with a factor other than the communication speed.

The description in the above-described embodiment has been given of a case in which the encoding mode is switched to the normal encoding mode when the error recovery period (i.e., the recovery period TA or the error-slice recovery period TEN) is finished. The present invention is not limited to this arrangement, and the encoding mode can be switched to the normal encoding mode at any timing.

In addition, a case in which only inter coding is executed in the normal encoding mode has been described in the above-described embodiment. The present invention is not limited to this arrangement, and both the inter coding and intra coding may be executed. For example, in the normal encoding mode, an intra coding system in which there is no restriction on the motion-vector search range and the deblocking-filter processing may be executed, and in the propagation-prevention encoding mode, a restriction that is similar to the restriction in the above-described embodiment may be imposed on the motion-vector search range and the deblocking-filter processing.

In addition, the description in the above-described embodiment has been given of a case in which switching between the normal encoding mode and the propagation-prevention encoding mode is performed for each slice. The present invention is not limited to this arrangement, and any timing may be employed for the switching. For example, the switching may be performed for each of the macroblocks along the error propagation range AI.

Additionally, the description in the above-described embodiment has been given of a case in which an error is detected when the value that deviates from the predetermined rule is detected. The present invention is not limited to this arrangement, and can also be applied to, for example, a case in which an error is detected when an error resulting from packet loss or CAVLC is detected.

Various changes can be made to the propagation encoding system. For example, when the method for generating sub-integer-precision pixels (i.e., the method for excluding error propagation pixels) is modified for the motion prediction processing or when the motion-vector search block has a size of 16×8, 8×8, 8×4, 4×8, or 4×4 pixels, a motion vector in the y direction can be detected by processing that is similar to the processing used when the number of encoding line units is two or more. The number of filter taps is not limited and, for example, one adjacent pixel or three or more adjacent pixels may be referred to. The same applies to the deblocking filter and thus the number of pixels to be referred to is not limited.

During deblocking-filter processing, not only disable_deblocking_filter_idc but also any method for the restriction may be used.

In addition, the arrangement may be such that multiple refresh lines RL appear in one picture. The same applies to the refresh block RL_B, and thus multiple refresh blocks RL_B may appear in one slice. A refresh block RL_B constituted by multiple×multiple macroblocks may appear for each constant-code-amount line constituted by multiple macroblock lines. In addition, in order to reduce the amount of delay, a line having a constant amount of code may be set to a sub-line (e.g., a ½ line).

The position of the refresh line RL may be varied so that it is shifted upward. Alternatively, the refresh line RL may appear randomly. The refresh block RL_B may also appear in each picture in accordance with a certain regulation. In addition, in the second propagation prevention system, the refresh line RL may appear overlapping two or more macroblock lines.

In addition, the size of the encoding unit is not limited. All blocks other than the enforced intra blocks may also be assigned to inter blocks. Also, for example, the pixel values may be directly encoded and the intra prediction processing does not necessarily have to be executed on the enforced intra macroblocks.

In addition, the description in the above embodiment has been given of a case in which the encoding processing is executed in accordance with the H.264/AVC system. The present invention is not limited to this arrangement, and the encoding processing may be executed in accordance with any encoding system in which motion prediction processing and deblocking-filter processing with sub-integer precision are executed with reference to at least adjacent pixels.

Additionally, the description in the above embodiment has been given of a case in which only an immediately previous picture is referred to during inter coding. The present invention is not limited to this arrangement, and a forward picture, for example, a last-but-one picture, may be referred to.

In addition, the description in the above embodiment has been given of a case in which the present invention is applied to a wall-hanged television that serves as a wireless video-data transmission system. The present invention is not limited to this arrangement and can be applied to any system in which video data is transmitted/received and displayed in real time. For example, the present invention can be applied to video conferences or wired systems using the Internet through optical cables, telephone lines, and so on.

In addition, the description in the above embodiment has been given of a case in which an IEEE 802.11n system is used as the wireless transmission system. The present invention is not limited to this arrangement, and the wireless transmission system is not limiting.

In addition, the description in the above embodiment has been given of a case in which the encoding program and so on are pre-stored in a ROM (read only memory), a hard disk drive, or the like. The present invention is not limited to this arrangement, and the encoding program and so on may be installed from an external storage medium, such as a Memory Stick (registered trademark of Sony Corporation), onto a flash memory or the like. The arrangement may also be such that the encoding program and so on are externally obtained via a USB (universal serial bus), an Ethernet® link, or a wireless LAN (local area network) based on IEEE 802.11a/b/g or the like and are further distributed via terrestrial digital television broadcast or BS digital television broadcast.

Additionally, the description in the above embodiment has been given of a case in which the video processing apparatus 1 serving as a video transmitting apparatus includes the search-range setting section 16 serving as a correspondent-pixel generator and a search-range setting section, the motion predictor/compensator 14 serving as a motion predictor, the slice-header generator 12 serving as a setting section, the deblocking filter 26, the transmitter/receiver 6 serving as a bit-stream transmitter and an error receiver, and the encoding-mode switching section 29. The present invention is not limited to this arrangement. For example, the video transmitting apparatus according to the embodiment of the present invention may include a correspondent-pixel generator, a search-range setting section, a setting section, a deblocking filter, a bit-stream transmitter, an error receiver, an encoding-mode switching section which have various configurations other than those described above. The video transmitting apparatus does not necessarily have to include the digital broadcast receiver 2, the digital tuner section 3, and the audio encoder 5.

In addition, the description in the above embodiment has been given of a case in which the display apparatus 30 serving as the video receiving apparatus includes the transmitter/receiver 31 serving as a bit-stream receiver and an error transmitter, the reversible-decoding section 42, and the error detector 43. The present invention is not limited to this arrangement, and the video receiving apparatus according to the embodiment of the present invention may include a bit-stream receiver, a reversible-decoding section, an error detector, and an error transmitter which have various configurations other than those described above. The video receiving apparatus does not necessarily have to include the audio decoder 34, the speaker 35, and the display section 33.

The present application contains subject matter related to that disclosed in Japanese Priority Patent Application JP 2009-201796 filed in the Japan Patent Office on Sep. 1, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A video transmitting apparatus comprising:
an error receiver that receives, from a video receiving apparatus for receiving a bit stream resulting from encoding of video data including pictures, error information indicating that an error is detected;
an encoding-mode selector that selects a propagation-prevention encoding mode as an encoding mode when the error receiver receives the error information, wherein in the propagation-prevention encoding mode, intra coding is executed on a forced intra block, a search range is set for a reference encoding unit so that the search range does not include correspondent pixels from a boundary line serving as a boundary between the forced intra block and a block other than the forced intra block, the correspondent pixels corresponding to the number of adjacent pixels, and a restriction is set on deblocking-filter processing through a change in deblocking-filter setting information; and
an encoder that encodes the video data in accordance with the encoding mode selected by the encoding-mode selector.

2. The video transmitting apparatus according to claim 1, wherein, when the error receiver does not receive the error information, the encoding-mode selector selects a normal encoding mode as the encoding mode.

3. The video transmitting apparatus according to claim 1, wherein, when an error recovery period for recovery from the error is finished, the encoding-mode selector switches the encoding mode to the normal encoding mode.

4. The video transmitting apparatus according to claim 3, wherein, in the normal encoding mode, encoding is performed by using only forward prediction coding.

5. The video transmitting apparatus according to claim 4, wherein, when a position of the error in the bit stream is identifiable, the encoding-mode selector applies the propagation-prevention encoding mode to an error propagation prevention area including an error propagation range in which the error is likely to propagate.

6. The video transmitting apparatus according to claim 5, wherein, on a basis of error position information that is added to the error information and that indicates the position of the error, the encoding-mode selector identifies the error propagation prevention area.

7. The video transmitting apparatus according to claim 5, wherein, in accordance with error propagation information that is added to the error information and that indicates the error propagation range, the encoding-mode selector identifies the error propagation prevention area.

8. The video transmitting apparatus according to claim 6, wherein the encoding-mode selector switches the encoding mode for each predetermined slice.

9. The video transmitting apparatus according to claim 8, wherein, when the position of the error in the bit stream is unidentifiable, the encoding-mode selector applies the propagation-prevention encoding mode to an entire area of the picture.

10. The video transmitting apparatus according to claim 9, wherein the encoding-mode selector selects one of multiple propagation prevention systems for the propagation-prevention encoding mode, in accordance with a speed of communication between the video transmitting apparatus and the video receiving apparatus for receiving the video data.

11. The video transmitting apparatus according to claim 10, further comprising:
a video-data receiver that receives the video data; and
a forced-intra-block assigner that assigns, when the video data received by the data receiver is to be encoded by intra coding and forward inter coding, encoding units to forced intra blocks or blocks other than the forced intra blocks so that all the encoding units in the pictures become forced intra blocks at a constant cycle.

12. The video transmitting apparatus according to claim 11, wherein the video transmitting apparatus generates the bit stream in accordance with an H.264 advanced video compression system.

13. A video receiving apparatus comprising:
a bit-stream receiver that receives a bit stream transmitted from a video transmitting apparatus, the bit stream resulting from encoding of video data including pictures;
a reversible-decoding section that performs reversible decoding on the bit stream;
an error detector that detects an error from data of an encoding unit in the bit stream reversible-decoded by the reversible-decoding section, by recognizing that an error exists when a value that deviates from a rule predetermined with the video transmitting apparatus is detected; and
an error transmitter that adds, when the error detector detects the error, error position information or error propagation information to error information indicating that the error is detected and that transmits the resulting error information to the video transmitting apparatus, the error position information indicating a position at which the error is detected and the error propagation information indicating an error propagation range in which the error is likely to propagate.

14. The video receiving apparatus according to claim 13, wherein the value that deviates from the predetermined rule is a value having a low use frequency.

15. The video receiving apparatus according to claim 14, wherein the predetermined rule is to restrict a maximum value of a motion vector, restrict a minimum value of a block size for motion compensation, restrict a maximum value of a difference value of quantization parameters between macroblocks, restrict a range in which a macroblock mode is allowed, or restrict a range in which a direction in intra prediction is allowed.

16. The video receiving apparatus according to claim 15, wherein the bit-stream receiver detects loss of a packet in the bit stream; and
in response to the packet loss, the error transmitter transmits, to the video transmitting apparatus, error information indicating that the error is detected.

17. A video transmitting method comprising the steps of:
receiving, from a video receiving apparatus for receiving a bit stream resulting from encoding of video data including pictures, error information indicating that an error is detected;
selecting a propagation-prevention encoding mode as an encoding mode when the error information is received in the error-information receiving step, wherein in the propagation-prevention encoding mode, intra coding is executed on a forced intra block, a search range is set for a reference encoding unit so that the search range does not include correspondent pixels from a boundary line serving as a boundary between the forced intra block and a block other than the forced intra block, the correspondent pixels corresponding to the number of adjacent pixels, and a restriction is set on deblocking-filter processing through a change in deblocking-filter setting information; and
encoding the video data in accordance with the encoding mode selected in the encoding-mode selecting step.

18. A video receiving method comprising the steps of:
receiving a bit stream resulting from encoding of video data including pictures;
performing reversible decoding on the bit stream;
detecting an error from data of an encoding unit in the bit stream reversible-decoded in the reversible-decoding step, by recognizing that an error exists when a value that deviates from a rule predetermined with a video transmitting apparatus is detected; and
adding, when the error detector detects the error, error position information or error propagation information to error information indicating that the error is detected and transmitting the resulting error information to the video transmitting apparatus, the error position information indicating a position at which the error is detected and the error propagation information indicating an error propagation range in which the error is likely to propagate.
